(19) United States
(12) Patent Application Publication
(10) Pub. No.: US 2024/0339593 A1
(43) Pub. Date: Oct. 10, 2024

(54) POST-GRAPHENE NANOHYBRID COMPOSITES, METHODS OF MAKING SAME, AND USES THEREOF

(71) Applicant: The Research Foundation for The State University of New York, Buffalo, NY (US)

(72) Inventors: Huamin LI, Buffalo, NY (US); Fei YAO, Amherst, NY (US)

(21) Appl. No.: 18/627,394

(22) Filed: Apr. 4, 2024

Related U.S. Application Data
(60) Provisional application No. 63/457,093, filed on Apr. 4, 2023.

(51) Int. Cl. H01M 4/36; C25B 11/091; H01G 11/36; H01M 4/02; H01M 4/58; H01M 4/587; H01M 4/86; H01M 4/90

(52) U.S. Cl. CPC H01M 4/364; C25B 11/091; H01G 11/36; H01M 4/5815; H01M 4/587; H01M 4/8652; H01M 4/90; H01M 2004/027; H01M 2004/8684

(57) ABSTRACT

Nanohybrid composites, methods of making nanohybrid composites, and uses of nanohybrid composites. A nanohybrid composite may be a binary nanohybrid composite comprising MXene and dual-phase MoS₂. A nanohybrid composite may be a ternary nanohybrid composite comprising MXene, dual-phase MoS₂, and a plurality of carbon nanotubes. A nanohybrid composite may be made by a method comprising contacting a liquid or liquid(s), a MXene or MXenes, a sulfur precursor or sulfur precursors, a molybdenum precursor or molybdenum precursors, optionally, an ammonium precursor or ammonium precursors, and, optionally, carbon nanotubes to form a reaction mixture; heating the reaction mixture, where the nanohybrid composite is formed. Anodes may comprise one or more nanohybrid composite(s). Devices, such as, for example, batteries or the like, may comprise one or more anode(s) comprising one or more nanohybrid composite(s) and/or one or more nanohybrid composite(s).

### CROSS REFERENCE TO RELATED APPLICATIONS

This application claims priority to U.S. Provisional Application No. 63/457,093, filed on Apr. 4, 2023, the entire disclosure of which is hereby incorporated by reference.

### BACKGROUND OF THE DISCLOSURE

It is estimated that CO₂ emissions must be reduced by at least 50% to limit global warming to 2° C. by 2050 in order to avoid a future in which everyday life around the world is marked by climate change. The pressing need for carbon emission reduction calls for a move toward electrified mobility and expanded deployment of solar and wind on electric grids. As a result, high-performance electrical energy storage systems are in demand. Rechargeable lithium-ion batteries (LIBs) are the most widely used battery system in portable electronics and electric vehicles nowadays because of their high energy per unit mass, power-to-weight ratio, high-temperature performance, and low self-discharge. Nevertheless, conventional graphite anode exhibits a rather small theoretical maximum Li storage capacity (372 mAh g⁻¹) which is far from the satisfaction for the development of modern society. As a result, research has been conducted on various high-specific-capacity anode materials, such as nanostructured carbon, silicon, metal oxides, and two-dimensional (2D) layered transition metal dichalcogenides (TMDs), to further improve the performance of LIBs.

As a representative TMD, molybdenum disulfide (MoS₂) provides good electrochemical performance when employed as a LIB anode. Compared to the conventional graphite anode, MoS₂ exhibits three and a half times higher capacity (up to 1290 mAh g⁻¹) and an improved safety benefiting from less dendrite formation associated with an intermediate lithiation voltage (1.1˜2 V vs. Li/Li⁺). In addition, it shows a lower degree of volume expansion (103%) upon lithiation compared to Si (280% for Li₁₅Si₄ stoichiometry) with a better rate capability and capacity retention. However, the intrinsically low electrical conductivity arising from the semiconducting nature of the 2H phase has been a limiting factor for achieving a high-performance MoS₂-based anode.

Compared with a widely used carbonaceous framework such as graphene, MXenes, a group of 2D materials consisting of transition metal carbides/nitrides/carbonitrides, exhibit enriched material chemistry, relatively high electrical conductivity, and superior hydrophilicity rendering them an attractive alternative as the conductive frameworks. In contrast to the charge-neutral graphene, MXenes exhibit a negatively charged surface due to the existence of rich surface functional groups, such as —OH, —O, and —F, which not only enhance the dispersion of precursors but also promote the MoS₂ nucleation in the solvent, making MXenes a substrate candidate for the synthesis of MoS₂. Moreover, it has been reported that the MXene electrochemical properties strongly depended on the nature of surface terminal groups, which endow MXenes with an extra degree of freedom for the LIB performance optimization. For instance, the —F containing functional groups with a higher Li-ion diffusion barrier would impede the ion transport and decrease the capacity, highlighting the necessity of surface functionality modulation.

Recently, Ti₃C₂ MXene, one of the representative MXenes, has been composited with MoS₂ for LIB applications. A MoS₂ nanoflakes and Ti₃C₂ hybrid structure was synthesized by a hydrothermal method and reported a reversible discharge capacity of 614 mAh g⁻¹ at 0.1 A⁻¹ after 70 cycles. Further, intercalated MoS₂ nanosheets into partially oxidized Ti₃C₂ has been made and demonstrated a discharge capacity of 230 mAh g⁻¹ at 0.5 A g⁻¹ for 50 cycles. Finally, MoS₂-decorated Ti₃C₂ has been produced using a solid-phase sintering method and achieved 131.6 mAh g⁻¹ at 1 A g⁻¹ for 200 cycles. These materials mostly ascribed the improved anode performance of hybrid structures to the enlarged interlayer spacing after the composite integration and the inherent high conductivity of MXene compared with the single component anode.

Hydrogen shows great potential in reducing greenhouse gas emissions and improving energy efficiency due to its environmentally friendly nature and inherent high gravimetric energy density. Hydrogen gas can be generated via electrochemical water splitting based on the hydrogen evolution reaction (HER, 2H⁺+2e⁻→H). HER is a multistep reaction that starts with a Volmer step (H⁺+e⁻+*→H_{ads}). The intermediate H_{ads} is removed from the catalyst surface either by Tafel reaction (H_{ads}+H_{ads}→H₂+2*) or by Heyrovsky reaction (H⁺+H_{ads}+e⁻→H₂+*). The reaction kinetics is greatly affected by the number of available active sites (represented as * in the equation), the way H_{ads} interacts with the catalyst surface (i.e., hydrogen adsorption energy Δ_{Gads}), and electron transfer rate. It is well known that Pt-group metals (PGM) are excellent catalysts for HER, but their practical applications are limited by the high cost and scarcity. Therefore, the development of active HER catalysts made from low-cost materials is the key step in the utilization of hydrogen energy.

Recently, non-precious elements have been widely employed to construct HER catalysts which can be classified into two major groups including transition metals (such as Mo, W, and Co, etc.) and nonmetals (such as S, Se, and C, etc.). To date, efficient PGM-free HER electrocatalysts synthesized based on the above-mentioned non-precious elements have demonstrated outstanding HER catalytic activities because of their unique physical and chemical properties. For instance, ideal H adsorption energy, high metallicity, and PGM-like electronic configuration along with chemical environmental compatibility have been identified as origins of superior HER activity for metal sulfide/selenides/carbides. Among them, two-dimensional (2D) molybdenum disulfide (MoS₂) is regarded as a promising alternative to Pt due to its large surface area, near-zero Δ_{Gads}, and numerous structure engineering possibilities. The material properties of MoS₂ are determined by its polymorph types, namely hexagonal 2H or trigonal 1T phases. The intrinsically low electrical conductivity arising from the semiconducting nature of the 2H phase hinders the development of MoS₂-based electrocatalysts.

Hydrothermal methods have also been employed to synthesize 2H—MoS₂/MXene composites, but the low electrical conductivity of 2H phase MoS₂ is still a limiting factor for the overall catalytic performance.

### SUMMARY OF THE DISCLOSURE

In an aspect, the present disclosure provides nanohybrid composites. In various examples, nanohybrid composites are binary nanohybrid composites (e.g., binary nanohybrid composites comprising MoS₂ and MXene, or the like). In various examples, nanohybrid composites are ternary nanohybrid composites (e.g., ternary nanohybrid composites comprising MoS₂, MXene, and CNTs, or the like). In various examples, nanohybrid composites comprise dual-phase MoS₂ and a plurality of MXene layers. In various examples, a nanohybrid composite comprises a higher 1T content and lower oxidation degree of MXene than those previously described in the art. In various examples, nanohybrid composites further comprise a plurality of carbon nanotubes (CNTs). In various examples, nanohybrid composites (e.g., binary and/or ternary nanohybrid composites) comprise better overall electrode connectivity/conductivity.

In an aspect, the present disclosure provides methods of making nanohybrid composites (e.g., nanohybrid composites of the present disclosure). In various examples, a method produces nanohybrid composites, such as, for example, binary and/or ternary nanohybrid composites. In various examples, a method results in nanohybrid composites comprising a reduced content of fluorine, fluoride, or the like.

In an aspect, the present disclosure provides anodes. In various examples, an anode comprises one or more nanohybrid composite(s) of the present disclosure. In various examples, an anode is a hydrogen evolution reaction (HER) anode or the like.

In an aspect, the present disclosure provides devices. In various examples, a device comprises one or more nanohybrid composite(s) of the present disclosure. In various examples, a device comprises one or more anode(s) of the present disclosure.

In an aspect, the present disclosure provides uses of nanohybrid composites. In various examples, a use of nanohybrid composite(s) is a use of nanohybrid composite(s) of the present disclosure.

### BRIEF DESCRIPTION OF THE FIGURES

For a fuller understanding of the nature and objects of the disclosure, reference should be made to the following detailed description taken in conjunction with the accompanying figures.

FIG. 1 shows a schematic illustration of sample preparation. (a) Schematic illustrations of the preparation of 1T enriched-MoS₂/Ti₃C₂ MXene/CNT (TMC) composite through one-step solvothermal technique. The mechanism of ammonia ion intercalation induced MoS₂ phase transition is shown in (b), (c), and (d).

FIG. 2 shows morphology characterizations of the ternary structures. (a), (b), (c), and (d) are the SEM images of pure 1T enriched-MoS₂, Ti₃C₂ MXene, MoS₂/Ti₃C₂, and MTC100 (the number here indicates the content of CNT in the composite), respectively. The scale bars are 200 nm, 1 m, 200 nm, and 200 nm, respectively. (e) and (f) are the TEM image and HRTEM image of MTC composite, respectively. The scale bars are 200 nm and 20 nm, respectively. The corresponding EDS elemental mapping is shown in (h), (i), (j), (k), and (1). The scale bar for panel (h) is 100 nm. (g) The HRTEM image of MTC100 and the corresponding enlarged area is displayed to show clear MoS₂ edge structures. The scale bar is 50 nm.

FIG. 3 shows the structure characterization of the MTC composite. The XRD patterns (a) and the Raman spectra (b) of various as-synthesized samples.

FIG. 4 shows XPS characterization of the MTC composite. (a) The complete XPS survey spectra of MTC100. Deconvoluted XPS spectra showing the binding energy of (b) carbon, (c) oxygen, (d) molybdenum, (e) sulfur, and (f) titanium, respectively.

FIG. 5 shows the electrochemical performance evaluation. (a) Polarization curves measured at a scan rate of 5 mV/s and (b) Tafel plots for selected samples. (c) The Nyquist plot of different samples. (d) The turnover frequency versus potential plot. (e) The polarization curves of MTC100 before and after 1000 cycles of CV scans. (f) The time-dependent stability plot.

FIG. 6 shows the electrochemical results of MTC hybrids with different CNT ratios. The polarization curves (a), the Tafel plots (b), the Nyquist plots (c), and (d) the turnover frequency versus potential plots of MTC ternary composites with different CNT amounts.

FIG. 7 shows the SEM/EDS of DI-synthesized 2H—MoS₂/Ti₃C₂. (a) The SEM image of aqueous solvent synthesized MoS₂/Ti₃C₂ composite. (b) The EDS spectrum taken in the corresponding area marked in (a).

FIG. 8 shows the SEM/EDS of 2H—MoS₂/Ti₃C₂. The SEM image of 2H—MoS₂/Ti₃C₂ and its corresponding EDS mapping and EDS spectrum.

FIG. 9 shows the SEM/EDS of 1T and 2H phases coexisted dual phase (DP)-MoS₂/Ti₃C₂. The SEM image of DP-MoS₂/Ti₃C₂ and its corresponding EDS mapping and EDS spectrum. Compared with the DI-synthesized MoS₂/Ti₃C₂ composite (see FIG. 7 and FIG. 8), fewer TiO₂ particles along with lower O content were observed in the bisolvent-produced DP-MoS₂/Ti₃C₂, demonstrating successfully suppressed oxidation of MXene during the synthesis process. The low F content was also detected at different locations of the sample due to the introduction of F residual during the Al layer etching process using HCl/LiF, which is corresponding to the XPS analysis in FIG. 4. It is worth mentioning that the F content is barely detected in EDS in some locations of the sample due to the detection limit of EDS and the potential nonuniform distribution of the F content in the sample.

FIG. 10 shows additional TEM images of MTC hybrid. The TEM image (a) and HRTEM image (b) of as-synthesized MTC100. The enlarged view of the area marked in the orange box in (b) is shown in (c), which clearly shows the 1T phase MoS₂ atom arrangement.

FIG. 11 shows XRD comparison of MoS₂ synthesized in different solvents. The XRD pattern comparison for aqueous synthesized 2H—MoS₂ and as-synthesized DP-MoS₂.

FIG. 12 shows the Raman spectrum highlighting 1T phase MoS₂. The Raman spectra of DP-MoS₂ and MTC100 in order to show the MoS₂ phase features. Clear E_{1g} (280 cm⁻¹), E_{2g} (378 cm⁻¹), and A_{1g} (405 cm⁻¹) peaks corresponding to the vibration of atoms along in-plane (E_{1g}, E_{2g}) and out-of-plane (A_{1g}) directions have been detected and are in good agreement with the previous report for 2H-phase MoS₂. On the other hand, the observation of the J₁ (150 cm⁻¹), J₂ (219 cm⁻¹), and J₃ (336 cm⁻¹) phonon modes suggests a clear 1T component in the samples. The formation of the 1T phase is a result of NH₄⁺ intercalation during the synthesis process, leading to the MoS₂ crystal structure distortion. The existence of the 1T phase in DP-MTC100 is consistent with the HRTEM observation in FIG. 10c, where the 1T phase atomic coordination are clearly identified.

FIG. 13 shows the electrochemical result for 2H and DP-MoS₂. The polarization curve (a), the Tafel plot (b), and the Nyquist plot (c) of 2H—MoS₂ and DP-MoS₂.

FIG. 14 shows the ECSA results of different samples. The CV curves for different samples tested between −0.3V˜0.2V vs. RHE at scan rate of 50 mV/s to determine the electrochemical capacitance are shown in (a), (b), (c), (d), (e), (f), (g), and (h). The corresponding linear fitting of the anodic current density versus scan rate plot is shown in (i).

FIG. 15 shows the surface area and pore size characterization. (a) The isotherm N₂ adsorption/desorption curve and (b) the pore size distribution of different samples.

FIG. 16 shows a schematic illustration of n-BuLi treatment for MoS₂/MXene heterostructure.

FIG. 17 shows SEM (a) and TEM (b) images of the pristine MoS₂/MXene (p-MT) sample. HRTEM images of p-MT with the marked interlayer distances of MoS₂ flakes (c) and MXene sheets (d). (e) and (f) are the SEM and TEM images of the n-MT heterostructure. The interlayer distances of MoS₂ and MXene are shown in (g) and (h), respectively.

FIG. 18 shows Raman spectra (a) and XRD patterns (b) of pristine and n-BuLi treated MoS₂/MXene (n-MT) hybrid structures.

FIG. 19 shows deconvoluted XPS spectra of p-MT (top panel) and n-MT (bottom panel) showing the binding energy of Fluorine (a, d), Molybdenum (b, e), and Sulfur (c, f).

FIG. 20 shows galvanostatic charge/discharge profiles of p-MT (a) and n-MT (b). The cycling performance of the 2D heterostructures (c). Rate performance of n-MT (d) and Nyquist plot of the 2D hybrids (e).

FIG. 21 shows additional SEM images of the n-MT at different magnifications show obvious morphology evolution after the n-BuLi treatment. Additional SEM images of the n-MT at different magnifications show obvious morphology evolution after the n-BuLi treatment.

FIG. 22 shows additional HRTEM images of MXene in p-MT and n-MT with the interlayer spacing extracted.

FIG. 23 shows the SEM and EDS results of (a) p-MT and (b) n-MT. The atomic ratio of —F in p-MT (11.13%) is clearly higher compared with n-MT (0.3%), indicating the removal of —F content after n-BuLi treatment.

FIG. 24 shows the SAED pattern for (a) p-MT and (b) n-MT.

FIG. 25 shows the XPS complete survey of (a) p-MT and (b) n-MT.

FIG. 26 shows the CV curves of (a) p-MT and (b) n-MT. The CV curves shown in FIG. 26 are intentionally selected for the 5^{th} cycle for each sample to eliminate the influence of the SEI formation peak (˜0.5 V) which overlaps with the LiₓMoS₂ related peaks. In the case of p-MT, all the peaks correspond well with the plateaus (1.86 V/2.25 V; 1.3 V/1.6 V) observed in the GCD curve (see FIG. 20a). In the case of n-MT, a broad peak located at 0.5 V emerged, which is due to the decomposition of LiₓMoS₂induced by the prelithiation during n-BuLi treatment.

FIG. 27 shows the rate performance of (a) p-MT and (b) n-MT.

### DETAILED DESCRIPTION OF THE DISCLOSURE

This invention was made with the support of the New York State Energy Research and Development Authority (NYSERDA) under Agreement Number 138126 and NYSERDA may have rights in this invention.

Although claimed subject matter will be described in terms of certain embodiments and examples, other embodiments and examples, including embodiments and examples that do not provide all of the benefits and features set forth herein, are also within the scope of this disclosure. For example, various structural, logical, process step, and electronic changes may be made without departing from the scope of the disclosure.

As used herein, unless otherwise stated, “about,” “approximately,” “substantially,” or the like, when used in connection with a measurable variable such as, for example, a parameter, an amount, a temporal duration, or the like, are meant to encompass variations of, for example, a specified value including, for example, those within experimental error (which can be determined by for example, a given data set, an art accepted standard, and/or with a given confidence interval (e.g. 90%, 95%, or more confidence interval from the mean), such as, for example, variations of +/−10% or less, +/−5% or less, +/−1% or less, and +/−0.1% or less of and from the specified value) or to encompass alternatives to the members of the list that would be recognized by one of ordinary skill in the art as alternatives, where the members and the alternatives may define a genus or sub-genus, insofar as such variations are appropriate to perform in the context of the disclosure. As used herein, unless otherwise stated, the terms “about,” “approximate,” “at or about,” “substantially,” and “˜” can mean that the amount or value in question can be the exact value or a value that provides equivalent results or effects as recited in the sample claims or taught herein. That is, it is understood that amounts, sizes, formulations, parameters, and other quantities and characteristics are not and need not be exact, but may be approximate and/or larger or smaller, as desired, reflecting tolerances, conversion factors, rounding off, measurement error, and the like, and other factors known to those of skill in the art such that, for example, equivalent results, effects, or the like are obtained. In some circumstances, the value that provides equivalent results or effects cannot be reasonably determined. In general, an amount, size, formulation, parameter or other quantity or characteristic is “about,” “approximate,” or “at or about” whether or not expressly stated to be such. It is understood that where “about,” “approximate,” “at or about,” or “˜” is used before a quantitative value, the parameter also includes the specific quantitative value itself, unless specifically stated otherwise.

Ranges of values are disclosed herein. The ranges set out a lower limit value and an upper limit value. Unless otherwise stated, the ranges include the lower limit value, the upper limit value, and all values between the lower limit value and the upper limit value, including, but not limited to, all values to the magnitude of the smallest value (either the lower limit value or the upper limit value) of a range. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a numerical range of “about 0.1% to 5%” should be interpreted to include not only the explicitly recited values of about 0.1% to about 5%, but also, unless otherwise stated, include individual values (e.g., about 1%, about 2%, about 3%, and about 4%) and the sub-ranges (e.g., about 0.5% to about 1.1%; about 0.5% to about 2.4%; about 0.5% to about 3.2%, and about 0.5% to about 4.4%, and other possible sub-ranges) within the indicated range. It is also understood that there are a number of values disclosed herein, and that each value is also herein disclosed as “about” that particular value in addition to the value itself. For example, if the value “10” is disclosed, then “about 10” is also disclosed. Ranges can be expressed herein as from “about” one particular value, and/or to “about” another particular value. Similarly, when values are expressed as approximations, by use of the antecedent “about, it will be understood that the particular value forms a further disclosure. For example, if the value “about 10” is disclosed, then “10” is also disclosed.

As used herein, unless otherwise stated, the term “group” or “moiety” refers to a chemical entity that is monovalent (i.e., has one terminus that can be covalently bonded to other chemical species), divalent, or polyvalent (i.e., has two or more termini that can be covalently bonded to other chemical species). The term “group” also includes radicals (e.g., monovalent and multivalent, such as, for example, divalent radicals, trivalent radicals, and the like). Illustrative examples of groups or moieties include:

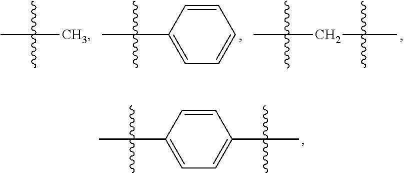

and the like.

The present disclosure provides, inter alia, nanohybrid composites. Also provided are methods of making and using nanohybrid composites of the present disclosure.

In an aspect, the present disclosure provides nanohybrid composites. In various examples, nanohybrid composites are binary nanohybrid composites (e.g., binary nanohybrid composites comprising MoS₂ and MXene, or the like). In various examples, nanohybrid composites are ternary nanohybrid composites (e.g., ternary nanohybrid composites comprising MoS₂, MXene, and CNTs, or the like). In various examples, nanohybrid composites comprise dual-phase MoS₂ and a plurality of MXene layers. In various examples, a nanohybrid composite comprises a higher 1T content and lower oxidation degree of MXene than those previously described in the art. In various examples, nanohybrid composites further comprise a plurality of carbon nanotubes (CNTs). In various examples, nanohybrid composites comprising a plurality of carbon nanotubes may be referred to as ternary nanohybrid composites. In various examples, nanohybrid composites (e.g., binary and/or ternary nanohybrid composites) comprise better overall electrode connectivity/conductivity. In various examples, a nanohybrid composite is formed by a method of the present disclosure. Non-limiting examples of nanohybrid composites are disclosed herein.

Nanohybrid composites comprise various components. In various examples, nanohybrid composites comprise MoS₂ or the like. In various examples, nanohybrid composites comprise MXene (e.g., a plurality of MXene layers) or the like. In various examples, nanohybrid composites comprise carbon nanotubes (e.g., a plurality of carbon nanotubes) (CNT) or the like. In various examples, a nanohybrid composite comprises MoS₂, MXene, and/or carbon nanotubes, and/or any combination thereof.

Nanohybrid composites comprise various component amounts (e.g., ratios or percentages of components of a composition). In various examples, nanohybrid composites comprise about 50 to about 90 wt % dual-phase MoS₂, based on a total weight of a nanohybrid composite, including all 0.1 wt % values and ranges therebetween. In various examples, nanohybrid composites comprise about 10 to about 50 wt % MXene (e.g., a plurality of MXene layers), based on a total weight of a nanohybrid composite, including all 0.1 wt % values and ranges therebetween. In various examples, nanohybrid composites comprise about 0 to about 20 wt % carbon nanotubes (e.g., a plurality of carbon nanotubes), based on a total weight of a nanohybrid composite, including all 0.1 wt % values and ranges therebetween. In various examples, a total wt % of a nanohybrid composite is equal to 100 wt %.

MoS₂ (e.g., dual-phase MoS₂) may have various geometries or ratios of geometries (e.g., 1T, 2H, or the like). In various examples, MoS₂ comprises a 1T phase higher than those previously described in the art. In various examples, about 30% or greater (e.g., wt % or mol % based on a total weight or total moles of MoS₂) of the dual-phase MoS₂ is 1T phase. In various examples, about 90% or less of the dual-phase MoS₂ is 1T phase. In various examples, about 30 to about 90% (e.g., wt % or mol % based on a total weight or total moles of MoS₂) of the MoS₂ is 1T phase, including all 0.1% values and ranges therebetween (e.g., about 35 to about 90%, about 40 to about 90%, about 45 to about 90%, about 50 to about 90%, about 55 to about 90%, about 55 to about 90%, about 60 to about 90%, about 65 to about 90%, about 70 to about 90%, about 75 to about 90%, about 80 to about 90%, about 85 to about 90% 1T phase, or the like). At least a portion, substantially all, or all of the remainder of MoS₂ (e.g., MoS₂ which is not 1T) is 2H phase. In various examples, a total MoS₂ of all phase geometries (e.g., 1T MoS₂, 2H MoS₂, and the like) combined is equal to 100% (e.g., wt % or mol % based on a total weight or total moles of MoS₂).

In various examples, nanohybrid composites comprise MXene/MXenes (e.g., a plurality of MXene layers or the like). Non-limiting examples of MXenes include Ti₃C₂, Ti₂C, Mo₂C, Nb₂C, Nb₄C₃, V₂C, V₄C₃, Ta₄C₃, Hf₃C₂, Ti₂N, W₂N, V₂N, Mo₂TiC₂, Mo₂Ti₂C₃, and the like, and any combination thereof. In various examples, MXenes are formed as described herein (e.g., via etching methods or the like).

Various carbon nanotubes can be used. Combinations of two or more different (e.g., structurally and/or compositionally different) types of carbon nanotubes can be used. In various examples, carbon nanotubes are multi-walled carbon nanotubes (MWCNTs), single-wall carbon nanotubes (SWCNTs), or the like, or any combination thereof. In various examples, at least a portion, substantially all, or all the carbon nanotubes are functionalized carbon nanotubes (e.g., carbon nanotubes comprising carboxylic acid and/or carboxylate group(s) or the like, fully or partially reduced carbon nanotubes, fully or partially oxidized carbon nanotubes, or the like, or any combination thereof). In various examples, at least a portion of, substantially all, or all the carbon nanotubes are doped carbon nanotubes (e.g., N-doped carbon nanotubes, S-doped carbon nanotubes, P-doped carbon nanotubes, or the like, or any combination thereof).

In various examples, a nanohybrid composite comprises a desirable amount of fluorine, fluoride, or the like (e.g. one or more group(s) comprising fluorine, fluoride, or the like, or compounds comprising fluorine, fluoride, or the like). In various examples, a nanohybrid composite comprises about 10% (e.g., about 10 wt % or about 10 mol %) or less fluorine, fluoride, or the like (e.g., about 9% or less, about 8% or less, about 7% or less, about 6% or less, about 5% or less, about 4% or less, about 3% or less, about 2% or less, about 1% or less, or the like). In various examples, a nanohybrid composite comprises less than about 1% (e.g., about 1 wt % or about 1 mol %) fluorine, fluoride, or the like.

A nanohybrid composite may comprise a plurality of ammonium ions (NH₄⁺). In various examples, a nanohybrid composite comprises a plurality of ammonium ions (NH₄⁺). In various examples, at least a portion or all the ammonium ions intercalate between adjacent MoS₂ layers (e.g., layers within a MoS₂ particle). Without intending to be bound by any particular theory, it is considered that the intercalated NH₄⁺ contributes to a phase transformation from 2H to 1T by stimulating a charge imbalance between Mo³⁺ and Mo⁴⁺, causing S plane sliding, MoS₂ crystal structure distortion, and expanded interlayer spacing, resulting in phase transformation from 2H to 1T.

Nanohybrid composites can have a desirable structure. In various examples, a nanohybrid composite comprises a plurality of planar layers (e.g., planar layers comprising MXene), each planar layer comprising two planar faces. In various examples, a nanohybrid composite comprises a plurality of planar layers, at least a portion of the planar layers stacked such that planar faces of adjacent planar layers are in separate planes. In various examples, a nanohybrid composite comprises interstitial layers (e.g., between adjacent stacked planar layers, or planar faces of planar layers) comprising MoS₂ (e.g., particles comprising MoS₂). In various examples, MoS₂ (e.g., particles comprising MoS₂) are in contact with (e.g., provide conductive and/or electrical communication between) at least two adjacent planar layers (e.g., planar layers comprising MXene). In various examples, a nanohybrid composite comprises alternating layers of planar layers comprising MXene and interstitial layers comprising MoS₂ (e.g., particles of MoS₂). In various examples, at least a portion of the plurality of MXene layers is stacked and MoS₂ is disposed between (e.g., in contact with) adjacent MXene layers. In various examples, a nanohybrid composite comprises carbon nanotubes (e.g., a plurality of carbon nanotubes), and each individual carbon nanotube has various contact geometries (e.g., contact geometries that are not particularly limited or defined relative to the other carbon nanotubes) with one or more of the planar layers (e.g., planar MXene layers) and/or the MoS₂ (e.g., particles of MoS₂). In various examples, a carbon nanotube contacts a surface or an edge of a planar MXene layer. In various examples, a carbon nanotube contacts MoS₂ (e.g., one or more particle(s) of MoS₂) and one or more surface(s) and/or edge(s) of one or more planar MXene layer(s) (e.g., adjacent MXene layer(s)).

Nanohybrid composites may have various desirable properties. In various examples, a nanohybrid composite comprises a double-layer capacitance of greater than or equal to about 40 mF/cm². In various examples, a nanohybrid composite comprises an electrochemical surface area of greater than or equal to about 1000 cm². In various examples, a nanohybrid composite comprises an overpotential less than or equal to about 180 mV. In various examples, a nanohybrid composite comprises a charge transfer resistance of about 20 ohm or less (e.g., about 10 ohm or less). In various examples, a nanohybrid composite has a turnover frequency (TOF) of about 0.01 to about 10 s⁻¹, including all 0.001 s⁻¹ values and ranges therebetween. In various examples, a nanohybrid composite has an interlayer distance or interlayer spacing of about 0.6 nm to about 1.6 nm, including all 0.01 nm values and ranges therebetween.

In various examples, one or more nanohybrid composite(s) is/are in the form of a pellet, a powder, a particle, a film, a sheet, a monolith, a suspension, or the like, or any combination thereof. In various examples, a pellet, a powder, a particle, a film, a sheet, a monolith, a suspension, or the like, or any combination thereof comprises one or more nanohybrid composite(s).

In various examples, an ink comprises one or more nanohybrid composite(s). In various examples, an ink is configured to fabricate a device or devices (e.g., microelectronic devices or the like, such as, for example, diodes (e.g., light-emitting diodes or the like) or the like).

In an aspect, the present disclosure provides methods of making nanohybrid composites (e.g., nanohybrid composites of the present disclosure). In various examples, a method produces nanohybrid composites, such as, for example, binary and/or ternary nanohybrid composites. In various examples, a method results in nanohybrid composites comprising a reduced content of fluorine, fluoride, or the like. Non-limiting examples of methods are disclosed herein.

In various examples, a method comprises preparing a reaction mixture. In various examples, a reaction mixture comprises one or more MXene(s), one or more sulfur precursor(s), one or more molybdenum precursor(s), and, optionally, one or more ammonium precursor(s). In various examples, a reaction mixture further comprises carbon nanotubes. In various examples, a reaction mixture further comprises one or more liquid(s) (e.g., a mixture of liquids), such as, for example, one or more solvent(s) or the like. In various examples, a reaction mixture further comprises one or more gel(s) (e.g., ion-containing gel(s), such as, for example, lithium-ion containing gel(s) or the like), one or more polymer(s) (e.g., ion-containing polymer(s), such as, for example, lithium-ion containing polymer(s) or the like), one or more glass(es) (e.g., ion-containing glass(es), such as, for example glass(es) comprising lithium ions or the like), or the like. In various examples, the reaction mixture is a solid-state reaction mixture. In various examples, a reaction mixture comprises a suspension of one or more of the component(s). In various examples, a reaction mixture is bi-phasic (e.g., comprises an aqueous phase, which may comprise (or be) a suspension of one or more of the component(s), and an organic phase, which may comprise (or be) a solution comprising one or more of the component(s)). In various examples, components (e.g., MXenes, sulfur precursors, molybdenum precursors, ammonium precursors, and/or optionally, carbon nanotubes) are added in any order.

In various examples, a method forms a reaction product. In various examples, a reaction product comprises or is one or more nanohybrid composite(s) (e.g., binary and/or ternary nanohybrid composite(s)) of the present disclosure.

In various examples, a method comprises preparing a reaction mixture by contacting a mixture of a liquids with MXene(s), sulfur precursor(s), molybdenum precursor(s), and optionally, ammonium precursor(s). In various examples, a reaction mixture further comprises carbon nanotubes. In various examples, components (e.g., mixture of liquids, MXene, sulfur precursor, molybdenum precursor, ammonium precursor, and/or optionally, carbon nanotubes) are added in any order.

A method can be carried out with or without one or more liquid(s), such as, for example, solvent(s) or the like. In various examples, a method is carried out using one or more solvent(s) (a reaction mixture comprises one or more solvent(s) or the like). In various examples, solvent(s) is/are chosen from organic solvent(s) (such as, for example, polar solvents, polar aprotic solvents, and the like, and any combination thereof). In various examples, organic solvent(s) is/are chosen from N,N-dimethylformamide (DMF), ethanol, N-methyl pyrrolidone, ethylene glycol, or the like, or any combination thereof.

A method can be carried out at various reaction temperatures. In various examples, a reaction mixture is heated (e.g., with or without an exogeneous heat source). In various examples, a reaction temperature is about 180 to about 220° C., including all 0.1° C. values and ranges therebetween. In various examples, a method is carried out without cooling a reaction mixture with an exogeneous cooling source. In various examples, a reaction mixture is cooled with an exogeneous cooling source.

A method can be carried out for various reaction times. The reaction time can depend on factors such as, for example, temperature, pressure, presence and/or efficiency of a catalyst and/or activator, presence and/or intensity of an applied energy source, mixing (e.g., stirring or the like), or the like, or a combination thereof. In various examples, reaction times range from about 12 hours to about 120 hours, including all integer minute values and ranges therebetween, or any combination thereof (e.g., where each step is performed at a different time as other steps). In various examples, a reaction mixture is held for a time sufficient to achieve a desired nanohybrid composite composition, structure, yield, or the like, or any combination thereof.

In various examples, a method further comprises isolation of a reaction product from a reaction mixture. In various examples, one or more nanohybrid composite(s) prepared by a method as described herein is/are isolated. Suitable isolation methods are known in the art. In various examples, at least a portion or all of the nanohybrid composite(s) is/are isolated by filtration, centrifugation, drying, or the like.

In various examples, a method further comprises contacting a reaction product (such as, for example, a binary and/or a ternary nanocomposite) with a lithiated base. Various lithiated bases can be used. Non-limiting examples of lithiated bases include, n-butyllithium, t-butyllithium, lithium diisopropylamide, lithium-biphenyl (Li-Bp), lithium-tetrahydrofuran (THF), and the like, and any combination thereof. In various examples, a nanohybrid composite is contacted with a lithiated base under inert conditions and/or at about room temperature.

Various MXenes can be used. Non-limiting examples of MXenes include Ti₃C₂, Ti₂C, Mo₂C, Nb₂C, Nb₄C₃, V₂C, V₄C₃, Ta₄C₃, Hf₃C₂, Ti₂N, W₂N, V₂N, Mo₂TiC₂, Mo₂Ti₂C₃, and the like, and any combination thereof. In various examples, a MXene is derived from a MXene precursor or the like. Non-limiting examples of MXene precursors include Ti₃AlC₂, Mo₂Ga₂C, Nb₂AlC, Nb₄AlC₃, V₂AlC, V₄AlC₃, Ta₄AlC₃, Mo₂TiAlC₂, Mo₂Ti₂AlC₃, Hf₃[Al(Si)]₄C₆, Ti₂AlN, and the like, and any combination thereof. In various examples, MXene precursors are commercially available. In various examples, MXene precursors are home-made precursors (e.g., made using a high-temperature sintering process with elemental powders).

In various examples, a method further comprises, prior to the contacting, etching a MXene precursor, whereby forming the MXene. Non-limiting examples of etching methods include acidic aqueous solvent etching (e.g., etching with HF, HF/HCl, HF/H₂SO₄, LiF/HCl, CoF₂/CoF₃/HCl, or the like, or any combination thereof), alkali aqueous solvent etching (e.g., KOH or the like), non-aqueous solvent etching (NH₄HF₂, NH₄PF₆, CH₃SO₃H in polar organic solvent, or the like, or any combination thereof), electrochemical etching, halogen etching, molten salt etching, and the like, and any combination thereof. In various examples, a MXene is formed by contacting a MXene precursor with hydrofluoric acid (e.g., hydrofluoric acid etching). In various examples, hydrofluoric acid is prepared in situ (e.g., via reaction of lithium fluoride and hydrochloric acid).

Various molybdenum precursors can be used. Non-limiting examples of molybdenum precursors include ammonium molybdate, molybdenum oxide, sodium molybdate, and the like, and any combination thereof.

Various ammonium precursors can be used. Non-limiting examples of ammonium precursors include ammonium heptamolybdate (NH₄Mo₇O₂₄), ammonium molybdate tetrahydrate ((NH₄)₆Mo₇O₂₄·4H₂O), ammonium tetrathiomolybdate ((NH₄)₂MoS₄), ammonium thiomolybdate ((NH₄)₂Mo₃S₁₃), and the like, and any combination thereof. In various examples, ammonium is produced by decomposition of one or more solvents (e.g., solvents in the mixture of liquids) (e.g., decomposition of DMF).

Various sulfur precursors can be used. Non-limiting examples of sulfur precursors include thiourea, sulfur powder, sodium thiocyanate, sodium sulfide, L-cystine, ammonium polysulfide ((NH₄)₂Sₓ), ammonium tetrathiomolybdate ((NH₄)₂MoS₄), ammonium thiomolybdate ((NH₄)₂Mo₃S₁₃), and the like, and any combination thereof.

A single reaction component may function as two or more precursor components (e.g., any combination of a sulfur precursor, a molybdenum precursor, and an ammonium precursor). In various examples, a molybdenum precursor and an ammonium precursor are the same compound (e.g., ammonium molybdate or the like, or any combination thereof). In various examples, an ammonium precursor, sulfur precursor, and molybdenum precursor are the same compound (e.g., ammonium tetrathiomolybdate ((NH₄)₂MoS₄), ammonium thiomolybdate ((NH₄)₂Mo₃S₁₃), or the like, or any combination thereof).

A reaction mixture may be prepared using various liquids/mixtures of liquids (e.g., solvents and/or mixtures of solvents). In various examples, liquids or a mixture of liquids solvate or partially solvate one or more of the reaction mixture components. In various examples, a mixture of liquids comprises deionized water and an organic solvent. In various examples, an organic solvent is a polar solvent, such as, for example, N,N-dimethylformamide (DMF), ethanol, N-methyl pyrrolidone, ethylene glycol, or the like, or any combination thereof. In various examples, an organic solvent is a polar aprotic solvent, such as, for example, DMF or the like. In various examples, a mixture of liquids comprises about 20 to about 50% by volume, based on a total volume of the mixture of liquids, deionized water, including all 0.1% values and ranges therebetween, and the remaining percent by volume is an organic solvent, where a total % volume of the mixture of liquids equals 100%. In various examples, a mixture of liquids is about 1:1 (v/v) deionized water to organic solvent (e.g., DMF or the like).

In an aspect, the present disclosure provides anodes. In various examples, an anode comprises one or more nanohybrid composite(s) of the present disclosure. In various examples, an anode is a hydrogen evolution reaction (HER) anode or the like. Non-limiting examples of anodes are disclosed herein.

In an aspect, the present disclosure provides devices. In various examples, a device comprises one or more nanohybrid composite(s) of the present disclosure. In various examples, a device comprises one or more anode(s) of the present disclosure. Non-limiting examples of devices are disclosed herein.

A device can be various batteries. Non-limiting examples of batteries include secondary/rechargeable batteries, and the like. A battery may be an ion conducting battery. Non-limiting examples of ion-conducting batteries include lithium-ion conducting batteries, potassium-ion conducting batteries, sodium-ion conducting batteries, magnesium-ion conducting batteries, aluminum-ion conducting batteries, and the like. A battery may be a metal battery, such as, for example, a lithium-metal battery, a sodium metal battery, magnesium metal battery, or the like. A device may be a solid-state battery or a liquid electrolyte battery.

In various examples, a device, which may be a battery, comprising one or more nanohybrid composite(s) or anode(s) (e.g., anode(s) comprising one or more nanohybrid composite(s) of the present disclosure) of the present disclosure, comprises one or more cathode(s), which may comprise one or more cathode material(s). Examples of suitable cathode materials are known in the art. In various examples, the cathode material(s) is/are one or more lithium-containing cathode material(s), one or more potassium-containing cathode material(s), one or more sodium-containing cathode material(s), one or more magnesium-containing cathode material(s), one or more aluminum-containing cathode material(s), or the like. Examples of suitable cathode materials are known in the art. Non-limiting examples of lithium-containing cathode materials include lithium nickel manganese cobalt oxides, LiCoO₂, LiNi_{1/3}Co_{1/3}Mn_{1/3}O₂, LiNi_{0.5}Co_{0.2}Mn_{0.3}O₂, lithium manganese oxides (LMOs), lithium iron phosphates (LFPs), LiMnPO₄, LiCoPO₄, and Li₂MMn₃O₈, where M is chosen from Fe, Co, and the like, and combinations thereof, and the like, and combinations thereof. Non-limiting examples of sodium-containing cathode materials include Na₂V₂O₅, P2-Na_{2/3}Fe_{1/2}Mn_{1/2}O₂, Na₃V₂(PO₄)₃, NaMn_{1/3}Co_{1/3}Ni_{1/3}PO₄, Na_{2/3}Fe_{1/2}Mn_{1/2}O₂@graphene composites, and the like, and combinations thereof. Non-limiting examples of magnesium-containing cathode materials include magnesium-containing materials (such as, for example, MgMSiO₄ (M is Fe, Mn, or Co) materials and MgFePO₄F materials, and the like), FeS₂ materials, MoS₂ materials, TiS₂ materials, and the like. Any of these cathodes/cathode materials may comprise a conducting carbon aid.

In various examples, a device, which may be a battery, comprises a conversion-type cathode. Non-limiting examples of conversion-type cathode materials include air (e.g., oxygen), iodine, sulfur, sulfur composite materials, polysulfides, metal sulfides, such as, for example, MoS₂, FeS₂, TiS₂, and the like, and combinations thereof.

In various examples, a device, which may be a battery, further comprises an electrolyte (e.g., a solid electrolyte, liquid electrolyte, or the like). Examples of suitable electrolytes are known in the art.

In various examples, a device further comprises a current collector (e.g., disposed on at least a portion of one or more anode(s)). In various examples, a current collector is a conducting metal or metal alloy.

In various examples, one or more electrolyte(s), one or more cathode(s), one or more anode(s), and, optionally, one or more current collector(s) form a cell of a battery. In various examples, a battery comprises a plurality of cells. In various examples, each adjacent pair of cells is separated by a bipolar plate. The number of cells in a battery can correspond to performance requirements (e.g., voltage output and the like) of a battery and is not particularly limited. In various examples, a battery comprises about 1 to about 500 cells, including all integer numbers and ranges therebetween.

In various examples, a device is a sensor (e.g., a biological sensor, a gas sensor, or the like) or the like. In various examples, a device comprises one or more shield(s) (e.g., electromagnetic wave shield(s) or the like), each shield independently comprising one or more nanohybrid composite(s). In various examples, a device comprises one or more filter(s) (e.g., membrane filter(s) or the like) or the like, each filter independently comprising one or more nanohybrid composite(s). In various examples, a device is a microelectronic device or the like, such as, for example, a diode (e.g., a light-emitting diode or the like) or the like. In various examples, a device is a thin film transistor or the like.

In an aspect, the present disclosure provides uses of nanohybrid composites. In various examples, a use of nanohybrid composite(s) is a use of nanohybrid composite(s) of the present disclosure. Non-limiting examples of uses of nanohybrid composites are disclosed herein.

In various examples, nanohybrid composites are used for sensing (e.g., used in sensors or the like) or the like, such as, for example, biological sensing, gas sensing, or the like, or any combination thereof. In various examples, nanohybrid composites are used for shielding or the like, such as, for example, electromagnetic wave shielding or the like. In various examples, nanohybrid composites are used for filtration, such as, for example, membrane filtration or the like. In various examples, nanohybrid composites are used for tribological applications, such as, for example, for friction turning or the like. In various examples, nanohybrid composites are used for corrosion prevention or the like. In various examples, nanohybrid composites are used for wastewater purification or the like. In various examples, nanohybrid composites are used in inks or the like, such as, for example, inks for fabricating devices (e.g., microelectronic devices or the like, such as, for example, diodes (e.g., light-emitting diodes or the like) or the like). In various examples, nanohybrid composites are used in thin film transistors or the like.

The following Statements describe various examples of nanohybrid composites, methods of making same, and uses thereof that are not intended to be limiting in any manner.

Statement 1. A ternary composite comprising dual-phase MoS₂, a plurality of MXene layers, and a plurality carbon nanotubes, wherein 30-90% of the MoS₂ is 1T phase.

Statement 2. A ternary composite according to Statement 1, wherein 50 to 90 wt % of the ternary composite is the dual phase MoS₂.

Statement 3. A ternary composite according to Statement 1 or Statement 2, wherein 10 to 50 wt % of the ternary composite is the plurality of MXene layers.

Statement 4. A ternary composite according to any one of the preceding Statements, wherein 0 to 20 wt % of the ternary composite is the plurality of carbon nanotubes.

Statement 5. A ternary composite according to any one of the preceding Statements, wherein the MXene of the plurality of MXene layers is chosen from Ti₃C₂, Ti₂C, Mo₂C, Nb₂C, Nb₄C₃, V₂C, V₄C₃, Ta₄C₃, Hf₃C₂, Ti₂N, W₂N, V₂N, Mo₂TiC₂, Mo₂Ti₂C₃, and the like, and any combination thereof.

Statement 6. A ternary composite according to any one of the preceding Statements, further comprising a plurality of ammonium ions.

Statement 7. A ternary composite according to any one of the preceding Statements, wherein the ternary composite has a double-layer capacitance of greater than or equal to 40 mF/cm². Statement 8. A ternary composite according to any one of the preceding Statements, wherein the ternary composite has an electrochemical surface area of greater than or equal to 1000 cm². Statement 9. A ternary composite according to any one of the preceding Statements, wherein the ternary composite has an overpotential less than or equal to 180 mV.

Statement 10. A ternary composite according to any one of the preceding Statements, wherein the ternary composite has a charge transfer resistance of less 20 ohm (e.g., less than 10 ohm). Statement 11. A ternary composite according to any one of the preceding Statements, wherein at least a portion of the plurality of MXene layers are stacked and the dual-phase MoS₂ is disposed between adjacent MXene layers, and each carbon nanotube contacts one or more of the MXene layers and/or dual-phase MoS₂.

Statement 11a. A ternary composite according to any one of the preceding Statements, wherein the fluoride content is 10% or less.

Statement 12. A method of making a composite, comprising:
contacting in mixture of liquids, a MXene, a sulfur precursor, a molybdenum precursor, an ammonium precursor, and, optionally, carbon nanotubes to form a reaction mixture;
heating the reaction mixture;
isolating a reaction product from the reaction mixture; and
optionally, contacting the reaction product with a lithiated base, wherein the reaction product is the composite.

Statement 13. A method according to Statement 12, wherein the composite is a ternary composite according to any one of Statements 1 to 11a.

Statement 14. A method according to Statement 12 or Statement 13, wherein the method comprises contacting the reaction product with the lithiated base.

Statement 15. A method according to any one of Statements 12-14, wherein the lithiated base is chosen from n-butyllithium, t-butyllithium, lithium diisopropylamide, lithium-biphenyl (Li-Bp), lithium-tetrahydrofuran (THF), and the like, and any combination thereof.

Statement 16. A method according to any one of Statements 12-15, wherein the MXene is chosen from Ti₃C₂, Ti₂C, Mo₂C, Nb₂C, Nb₄C₃, V₂C, V₄C₃, Ta₄C₃, Hf₃C₂, Ti₂N, W₂N, V₂N, Mo₂TiC₂, Mo₂Ti₂C₃, and the like, and any combination thereof.

Statement 17. A method according to any one of Statements 12-16, wherein prior the contacting in the mixture of liquids, the MXene is prepared by contacting a MXene precursor with hydrofluoric acid.

Statement 18. A method according to Statements 17, wherein the hydrofluoric acid is generated in situ via reaction of lithium fluoride and hydrochloric acid.

Statement 19. A method according to any one of Statements 12-18, wherein the MXene precursor is chosen from Ti₃AlC₂, Mo₂Ga₂C, Nb₂AlC, Nb₄AlC₃, V₂AlC, V₄AlC₃, Ta₄AlC₃, Mo₂TiAlC₂, Mo₂Ti₂AlC₃, Hf₃[Al(Si)]₄C₆, Ti₂AlN, and the like, and any combination thereof.

Statement 20. A method according to any one of Statements 12-19, wherein the molybdenum precursor is ammonium molybdate, molybdenum oxide, sodium molybdate, and the like, and any combination thereof.

Statement 21. A method according to any one of Statements 12-20, wherein the ammonium precursor is ammonium molybdate, ammonium heptamolybdate (NH₄Mo₇O₂₄), ammonium molybdate tetrahydrate ((NH₄)₆Mo₇O₂₄·4H₂O), ammonium tetrathiomolybdate ((NH₄)₂MoS₄), ammonium thiomolybdate ((NH₄)₂Mo₃S₁₃), and the like, and any combination thereof.

Statement 22. A method according to any one of Statements 12-21, wherein the molybdenum precursor and ammonium precursor are the same.

Statement 23. A method according to any one of Statements 12-22, wherein the sulfur precursor is chosen from thiourea, sulfur powder, sodium thiocyanate, sodium sulfide, L-cystine, ammonium polysulfide ((NH₄)₂Sₓ), ammonium tetrathiomolybdate ((NH₄)₂MoS₄), ammonium thiomolybdate ((NH₄)₂Mo₃S₁₃), and the like, and any combination thereof.

Statement 24. A method according to any one of Statements 12-23, wherein the mixture of liquids comprises deionized water and an organic solvent.

Statement 25. A method according to Statement 24, wherein the organic solvent is a polar solvent (e.g., a polar aprotic solvent).

Statement 26. A method according to Statement 24 or Statement 25, wherein the organic solvent is N,N-dimethylformamide (DMF).

Statement 27. A method according to any one of Statements 24-26, wherein the mixture of liquids comprises 20 to 50% by volume deionized water.

Statement 28. A method according to Statement 27, wherein the remainder of the mixture of liquids is 20 to 50% by volume deionized water and the remaining percent by volume is the organic solvent.

Statement 29. A method according to any one of Statements 24-28, wherein the mixture of liquids is a 1:1 (v:v) deionized water to DMF.

Statement 30. A composite comprising dual-phase MoS₂ and a plurality of MXene layers, wherein 30-90% of the MoS₂ is 1T phase and the composite has a fluoride content of 10% or less.

Statement 31. A composite according to Statement 30, wherein 50 to 90 wt % of the composite is the dual phase MoS₂.

Statement 32. A composite according to Statement 30 or Statement 31, wherein 10 to 50 wt % of the composite is the plurality of MXene layers.

Statement 33. A composite according to any one of Statements 30-32, wherein the MXene of the plurality of MXene layers is chosen from Ti₃C₂, Ti₂C, Mo₂C, Nb₂C, Nb₄C₃, V₂C, V₄C₃, Ta₄C₃, Hf₃C₂, Ti₂N, W₂N, V₂N, Mo₂TiC₂, Mo₂Ti₂C₃, and the like, and any combination thereof.

Statement 34. A composite according to any one of Statements 30-33, further comprising a plurality of ammonium ions.

Statement 35. A composite according to any one of Statements 30-34, wherein the composite has a double-layer capacitance of greater than or equal to 40 mF/cm².

Statement 36. A composite according to any one of Statements 30-35, wherein the composite has an electrochemical surface area of greater than or equal to 1000 cm².

Statement 37. A composite according to any one of Statements 30-36, wherein the composite has an overpotential less than or equal to 180 mV.

Statement 38. A composite according to any one of Statements 30-37, wherein the ternary has a charge transfer resistance of less than 10 ohm.

Statement 39. A composite according to any one of the preceding Statements, wherein composite comprises the plurality of MXene layers are stacked and the dual-phase the dual-phase MoS₂ is disposed between adjacent MXene layers.

Statement 40. An article comprising a ternary composite according to any one of Statements 1-11a or a composite according to any one of Statements 30-39.

Statement 41. An article according to Statement 40, wherein the article comprises an anode.

Statement 42. An article according to Statement 40 or Statement 41, wherein the article is a battery or fuel cell.

The steps of the method described in the various examples disclosed herein are sufficient to carry out the methods of the present invention. Thus, in various examples, the method consists essentially of a combination of the steps of the methods disclosed herein. In various other examples, the method consists of such steps.

The following examples are presented to illustrate the present disclosure. They are not intended to limiting in any manner.

### Example 1

This example provides a description of nanohybrid composites (e.g., ternary nanohybrid composites) and methods of making same.

Two-dimensional (2D) molybdenum disulfide (MoS₂) has been recognized as a potential substitution of platinum (Pt) for electrochemical hydrogen evolution reaction (HER). However, the broad adoption of MoS₂ is hindered by its limited number of active sites and low inherent electrical conductivity. In this work, a one-step solvothermal synthesis technique was employed to construct a ternary hybrid structure consisting of dual-phase MoS₂, titanium carbide (Ti₃C₂) MXene, and carbon nanotubes (CNTs), and demonstrated synergistic effects for active site exposure, surface area enlargement, and electrical conductivity improvement of the catalyst. The dual-phase MoS₂ (DP-MoS₂) is directly formed on the MXene with CNTs acting as crosslinks between 2D islands. The existence of edge-enriched metallic phase MoS₂, the conductive backbone of MXene along with the crosslink function of CNTs clearly improves the overall HER performance of the ternary nanocomposite. Moreover, the integration of MoS₂ with MXene not only increases the interlayer distance of the 2D layers but also partially suppresses the MXene oxidation and the 2D layer restacking, leading to good catalytic stability. As a result, an overpotential of 169 mV and a low Tafel slope of 51 mV/dec was successfully achieved. This work paves a way for 2D-based electrocatalyst engineering and sheds light on the development of the next-generation noble metal-free HER electrocatalysts.

Herein is provided a design and construction of 1T phase-enriched MoS₂ and Ti₃C₂Tₓ MXene composites as HER catalysts using a one-step solvothermal method in a bisolvent media. To further improve the catalyst performance, carbon nanotubes (CNT) are introduced in the hybrid structure as crosslinks. The ternary composite not only improves the overall electrical conductivity but also prevents the undesired oxidation and restacking of 2D materials simultaneously. Moreover, it was observed that dual-phase MoS₂ (DP-MoS₂) nanoflakes were vertically integrated with MXene with the exposure of numerous edge sites which were catalytically active for the HER. As a result, an improved HER activity is achieved compared to pure 2H MoS₂ and other binary counterparts. The ternary composite exhibits an overpotential of 169 mV which is achieved at a current density of 10 mA/cm² and a low Tafel slope of 51 mV/dec with good stability.

### Results

### Preparation of the Dual-Phase MTC.

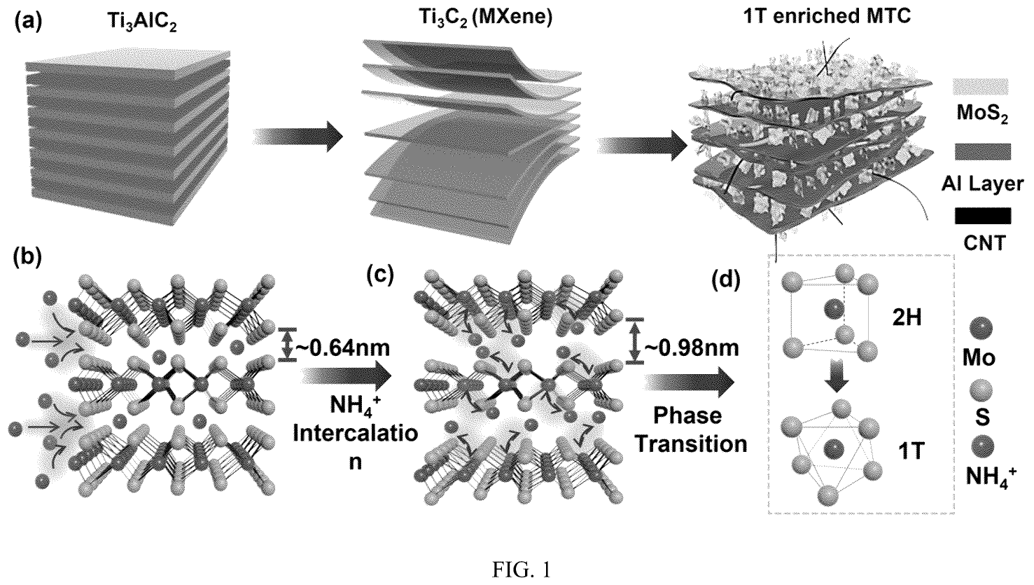

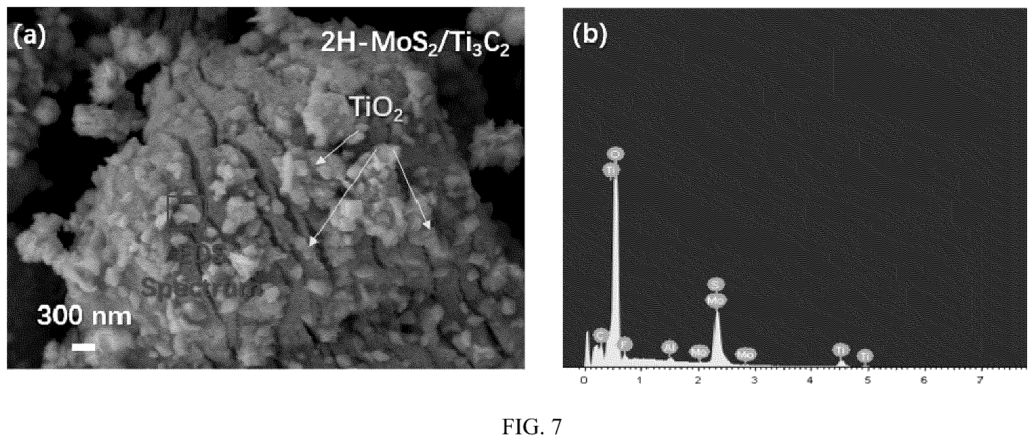

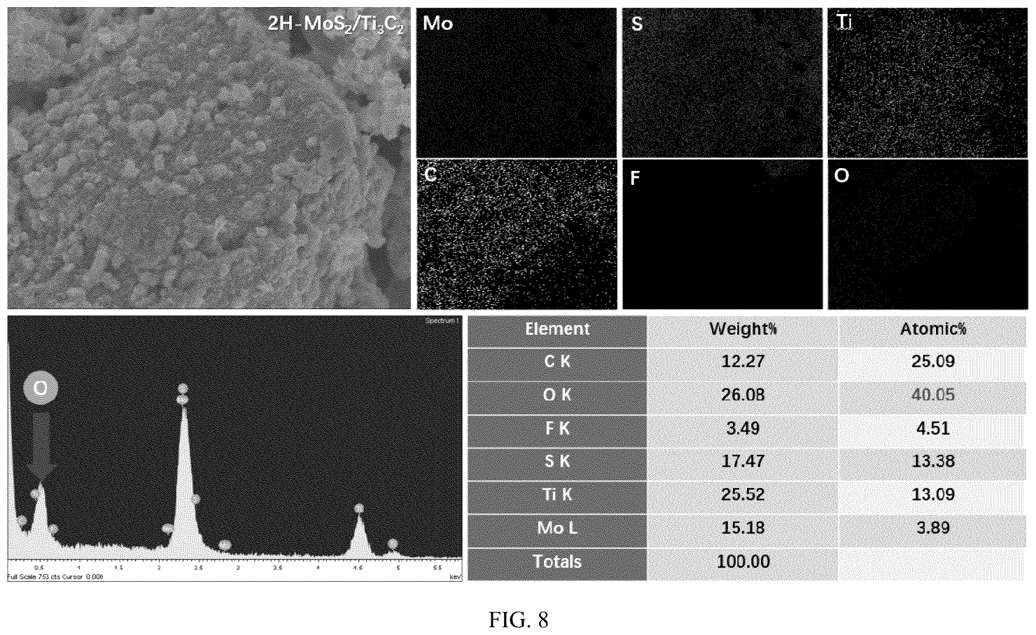

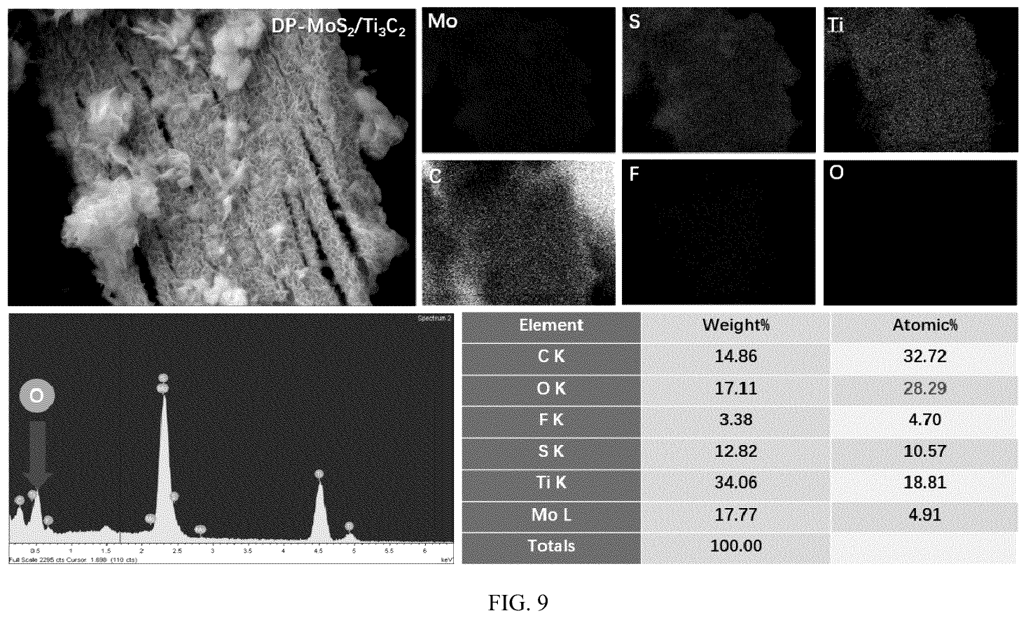

The dual-phase MoS₂/Ti₃C₂ MXene/CNT (DP-MTC) samples were prepared by a one-step bisolvent solvothermal synthesis technique and the schematic illustration of the preparation procedure can be found in FIG. 1a. Briefly, few-layered MXene flakes were prepared by the in situ HF etching method. The mixture of MXene and CNT powders were then added into DI water/DMF bisolvent along with ammonium molybdate and thiourea which served as Mo and S sources, respectively. The use of bisolvent is beneficial for promoting MoS₂ nucleation by increasing the solubility of MoS₂ precursors and improving the conductivity via triggering the 2H to 1T phase transition through ion intercalation. In addition, compared with the pure DI-based hydrothermal method, the adoption of bisolvent will preserve the high conductivity of the MXene matrix by improving the stability of MXene via reducing the undesired oxidation reaction. As shown in FIG. 7 and FIG. 8, a large amount of TiO₂ nanoparticles were found on the surface of the 2H—MoS₂/Ti₃C₂ composite synthesized in DI water along with high oxygen content, which is often observed in the previous reports. By contrast, the bisolvent-produced DP-MoS₂/Ti₃C₂ (FIG. 9) showed fewer TiO₂ particles and the oxygen content is much lower, demonstrating successfully suppressed oxidation of MXene.

Morphology, phase and structure characterization.

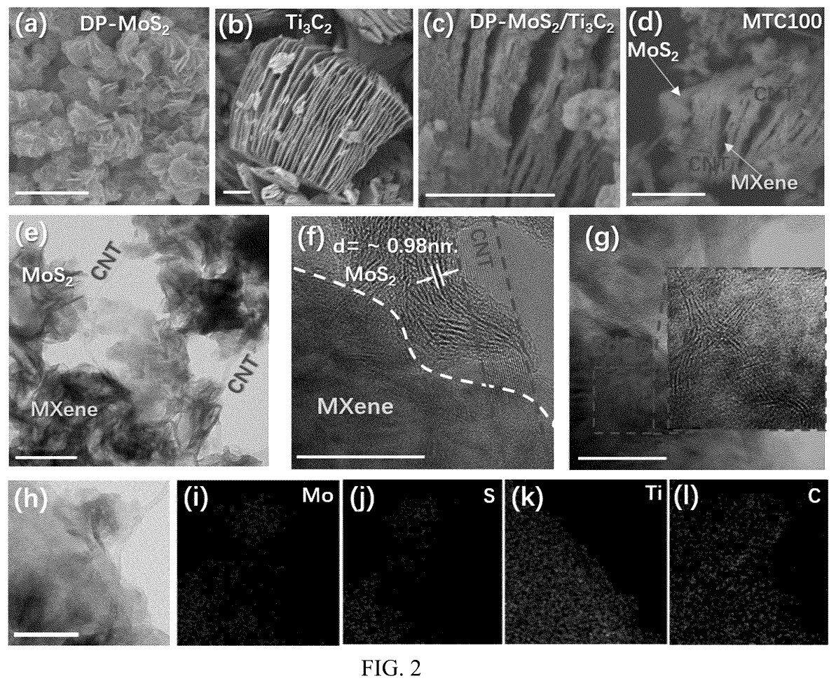

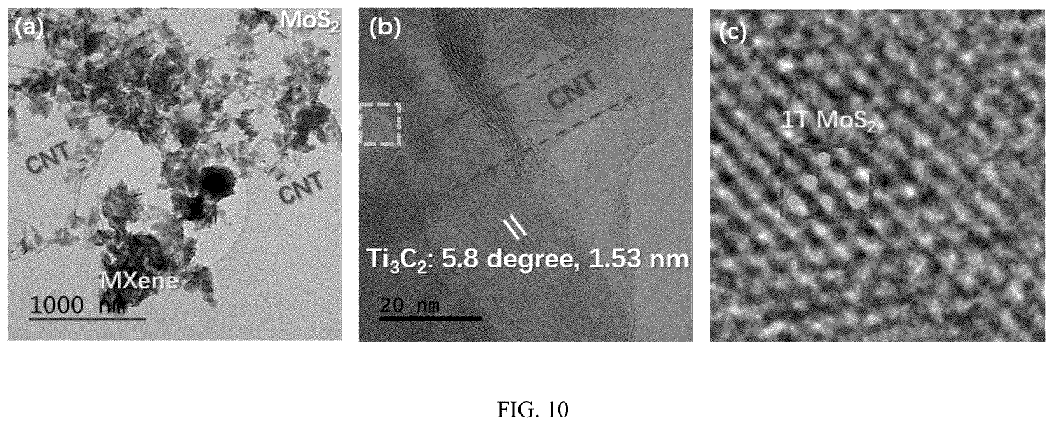

To confirm the structure and composition of the products, a series of characterizations were conducted. The SEM images of the as-synthesized materials are shown in FIG. 2. The morphologies of the dual-phase MoS₂ (DP-MoS₂) nanosheets and MXene layers are shown in FIG. 2a and FIG. 2b, respectively. Compared to the pure DP-MoS₂ flakes which exhibit a well-defined nanoflower-like structure with the tendency to form aggregated bundles, DP-MoS₂ flakes tend to grow in the interlayers as well as the surface of Ti₃C₂ MXene, as shown in FIG. 2c. Such a sandwiched binary DP-MoS₂/Ti₃C₂ structure will not only prevent the 2D layers from restacking but also protect the environmentally sensitive MXene from oxidation. The morphology of the ternary DP-MTC100 can be found in FIG. 2d, where the three components are clearly observed. The TEM image of DP-MTC100 (see FIG. 2e, more images can be found in FIG. 10a) displays a ternary composite consisting of 1D/2D hybrid structures. Although the density of CNTs is low, they served as a crosslink between the 2D islands and led to the formation of a well-connected conductive network, promoting electron transfer efficiency within the whole system. The EDS elemental mapping can be found in the bottom panel of FIG. 2 (FIGS. 2h-l) where the uniform distribution of Mo, S, Ti, and C elements are revealed. The interlayer distance of DP-MoS₂ in the as-synthesized ternary composite was extracted from the HRTEM image (FIG. 2f) and the value is ˜0.98 nm which is clearly larger than the pure 2H—MoS₂ obtained from in situ sulfurization method (˜0.64 nm). Besides that, the Ti₃C₂ MXene layers also exhibit an expanded interlayer spacing of ˜1.53 nm (FIG. 10b) compared to the typical reported value of 1 nm. The increased interlayer space can be ascribed to the NH₄ ions intercalation and the integrated stacking nature of the 2D layers, which will be discussed in detail later. Moreover, it was observed that a large portion of DP-MoS₂ flakes favors exposing edge sites (FIG. 2g) in the DP-MTC100 composite, leading to the involvement of numerous catalytic active sites for the future HER test.

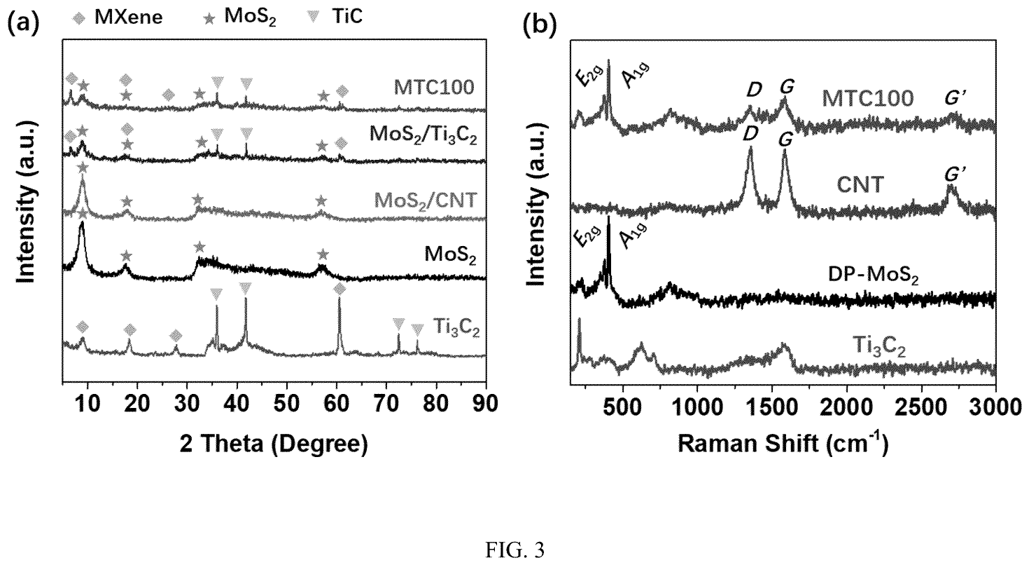

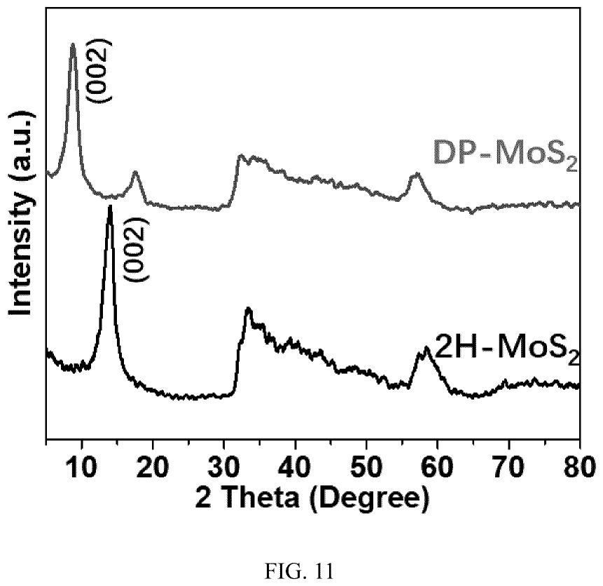

FIG. 3a shows the XRD patterns of various as-prepared samples. The diffraction pattern of Ti₃C₂ MXene shows obvious peaks at 9, 18.4, 27.7, and 60.5 degrees, corresponding to (002), (006), (008), and (110) crystal planes. The interlayer distance is extracted to be 0.98 nm and is close to the typical reported value of 1 nm. The absence of the Al peak at ˜38 degree suggests the successful etching of the Al layer from the MAX precursor. Two peaks located at 35.9 and 41.7 degrees come from TiC, which is the impurity in the MAX phase precursors. The DP-MoS₂ obtained via bisolvent synthesis exhibits major diffraction peaks at 9, 33.2, and 58.6 degrees, which are corresponding to the (002), (100), and (110) planes, respectively. Compared with the 2H—MoS₂ obtained in aqueous solvent (see FIG. 11), the (002) peak has downshifted from −14 degree to 9 degree, suggesting an expanded interlayer spacing. To analyze in detail, the interlayer spacing has been extracted using Bragg's diffraction equation, and the value is calculated to be 0.98 nm for DP-MoS₂, which is 0.34 nm larger than the reported value of 2H—MoS₂ (0.64 nm). In the bisolvent synthesis process, both ammonium molybdate and DMF can act as the abundant source of NH₄⁺. Interestingly, the 0.34 nm difference is very close to the size of NH₄⁺ ion (0.35 nm), indicating the expanded interlayer spacing of DP-MoS₂ could be attributed to the interaction of NH₄⁺ ions, as indicated in FIGS. 1b and 1c. A similar peak shift has been observed for DP-MoS₂/CNT composite as well. In the case of the DP-MoS₂/Ti₃C₂ composite, two peaks located at 6.6 and 8.9 degrees can be clearly identified, corresponding to the (002) planes of Ti₃C₂ and MoS₂ with enlarged interlayer distances of 1.5 nm and 0.99 nm, respectively. This result suggests that the interlayer spacing of both MoS₂ and Ti₃C₂ MXene were expanded simultaneously by forming the MoS₂/Ti₃C₂ composite with the assistance of ion intercalation and integrated 2D layer stackings. Similar interlayer distance expansion is observed in DP-MTC100, which corresponds well with previous TEM observations in FIG. 2f and FIG. 10b. However, compared with the DP-MoS₂/Ti₃C₂, no further (002) peak shift is observed in DP-MTC100, indicating that the addition of CNT does not impact the interlayer distance of MoS₂ and Ti₃C₂ MXene.

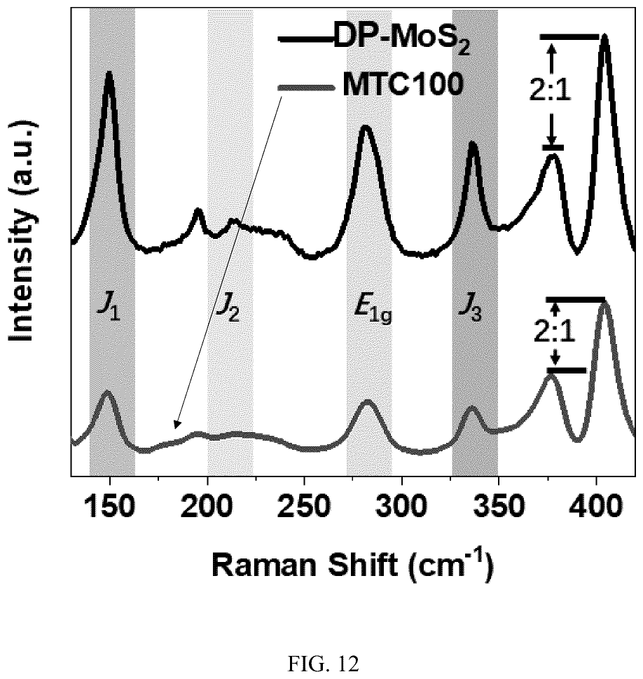

The Raman spectra of selected samples are shown in FIG. 3b. In the pure Ti₃C₂ MXene Raman spectrum, several peaks that appeared at the lower Raman shift region (below 1000 cm⁻¹) can be attributed to the C—Ti vibrations, and the peaks located at 1341 cm⁻¹ and 1583 cm⁻¹ reflect the carbon-based D band and G band vibrations, respectively. The as-synthesized DP-MoS₂ sample shows the characteristic E_{2g} and A_{1g} vibration peaks at 378 cm⁻¹ and 405 cm⁻¹, respectively, corresponding to the 2H phase characteristics. The relative intensity of A_{1g} to E_{2g} peaks provides insightful information related to the MoS₂ planes. The out-of-plane A_{1g} vibration mode in MoS₂ is preferentially excited for edge-terminated structure due to the polarization dependence. The A_{1g}/E_{2g} ratio is extracted to be as large as 2, indicating an edge-enriched MoS₂ structure (see FIG. 12). In addition to the 2H peaks, three 1T-MoS₂ related peaks (150, 219, and 336 cm⁻¹) are observed which can be ascribed to J₁, J₂, and J₃ vibration modes, respectively. The coexistence of 1T and 2H related peaks in the Raman spectrum proves the successful preparation of dual-phase MoS₂ using the bisolvent synthesis approach. The broad peak located at 820 cm⁻¹ can be attributed to the slightly oxidized MoS₂ product. In the case CNTs, the peak located at −1356 cm⁻¹, 1584 cm⁻¹, and 2695 cm⁻¹ can be attributed to the vibration modes of D, G, and G′ bands, respectively.

The DP-MTC100 sample exhibits both MoS₂ related peaks along with CNT-related vibration modes, indicating the successful formation of the ternary composite. It is worth noting that the Ti₃C₂-related Raman peaks are diminished due to the high surface coverage of MoS₂ and the intrinsically weak signal nature of Ti₃C₂. The unchanged A_{1g}/E_{2g} ratio suggests the edge-enriched MoS₂ morphology maintained in the MTC ternary composite, corresponding to the TEM result shown in FIG. 2g. Clear 1T-phase based Raman modes are observed in the MTC hybrid structure (see FIG. 12) as well suggesting the coexistence of 2H and 1T phases in the composite. The formation of the 1T phase is triggered by the ion intercalation. Specifically, the intercalated NH₄⁺ can stimulate the charge imbalance between Mo³* and Mo⁴⁺ and cause the S plane sliding and therefore the MoS₂ crystal structure distortion along with expanded interlayer spacing, resulting in the phase transformation from 2H to 1T eventually, as shown in FIGS. 1c and 1d. The existence of the 1T phase is further proved by the HRTEM image of DP-MTC100, as shown in FIG. 10c, where the 1T phase atomic coordination can be clearly identified.

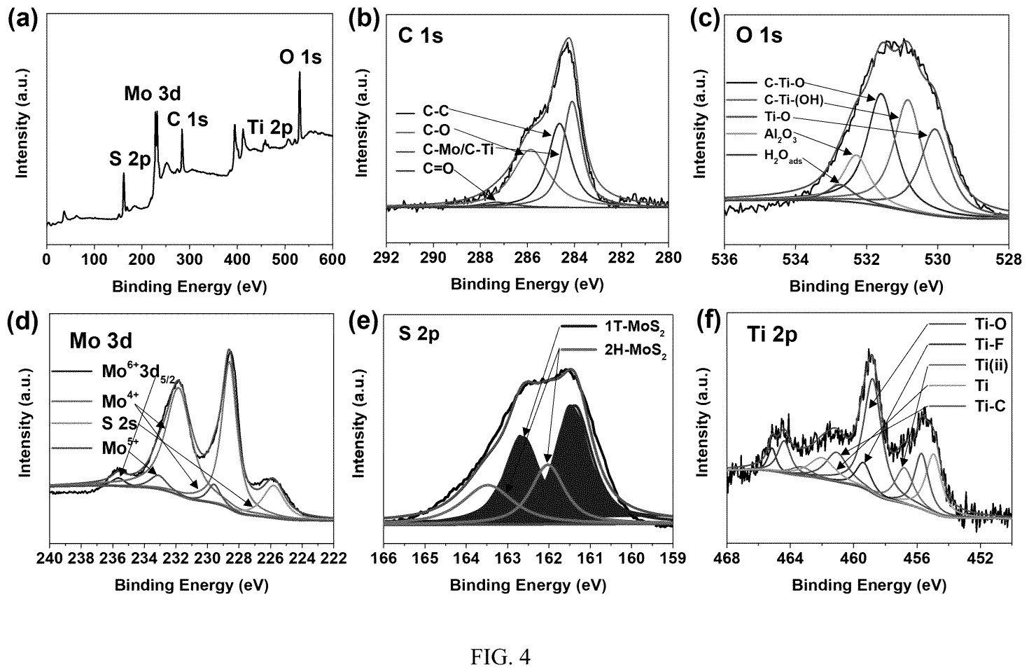

To investigate the chemical composition of the as-synthesized DP-MTC100, XPS analysis was performed. The complete survey spectrum is shown in FIG. 4a where the characteristic peaks of C, O, Mo, S, and Ti can be clearly observed. To analyze the details for each element, peak deconvolution was carried out. As shown in FIG. 4b, four major peaks located at 284.1 eV, 284.85 eV, 285.85 eV and 287.3 eV for C1s spectra can be ascribed to the C—Mo/C—Ti, C—C, C—O, and C═O bonds, respectively, which are the typical bonding structures in MXene and CNT. The peaks at 530.9 eV and 531.6 eV in the O1s spectrum (FIG. 4c) originate from the C—Ti—(OH) and C—Ti—O, respectively, corresponding to the —(OH) and —O functional group attached on the Ti₃C₂ surface. The peak located at 530.1 eV can be assigned to the Ti—O bond which can be ascribed to the oxidation of the Ti₃C₂ MXene surface during the XPS measurement. In addition, although MXene oxidation is suppressed during the bisolvent synthesis compared to the aqueous-based method (see FIGS. 7, 8, and 9), a certain degree of undesired oxidation still took place during the solvothermal process. Moreover, two peaks at 532.3 eV and 532.8 eV can be attributed to the presence of Al₂O₃related to the incomplete Al layer etching from the MAX phase and the adhesive water associated with the high hydrophilicity of the MXene surface, respectively. In FIG. 4d, the peaks for Mo⁴⁺(d3/2) and Mo⁴⁺(d5/2) are located at 231.8 eV and 228.6 eV, respectively, with an S²⁺ peak at 225.8 eV. It is noteworthy that a doublet (at 229.6 eV and 233.1 eV) for Mo⁵⁺ were observed, which is beneficial for the MoS₂ stability. Besides that, Mo⁶⁺ shows a peak at 235.7 eV, suggesting partial oxidation of Mo, corresponding to the Raman observation in FIG. 3b. As for S 2p spectra, two doublets that emerged at 163.5/162.1 eV and 162.7/161.4 eV can be attributed to 2H—MoS₂ and 1T-MoS₂, respectively, reflecting the successful synthesis of mixed 1T and 2H phase MoS₂, which is in good agreement with the previous TEM and Raman analysis in FIG. 10c and FIG. 12, respectively. The calculation was based on S 2p peak deconvolution suggested that the content of 1T phase MoS₂ is around 66%, indicating a 1T-phase enriched structure in the dual-phase MoS₂. FIG. 4f displays the Ti²p spectra. The doublet located at 464.3 eV and 458.9 eV can be assigned to the Ti—O bond and resonate well with the observation in FIG. 4c. The two peaks at 465.1 eV and 459.4 eV represent the Ti—F bond, which is introduced during the Al layer etching process using HCl/LiF. The Ti—C bond-related peaks are observed at 461.2 eV and 456.6 eV, respectively, which are consistent with previous reports for MXene structures.

The HER performance and electrochemical characterizations.

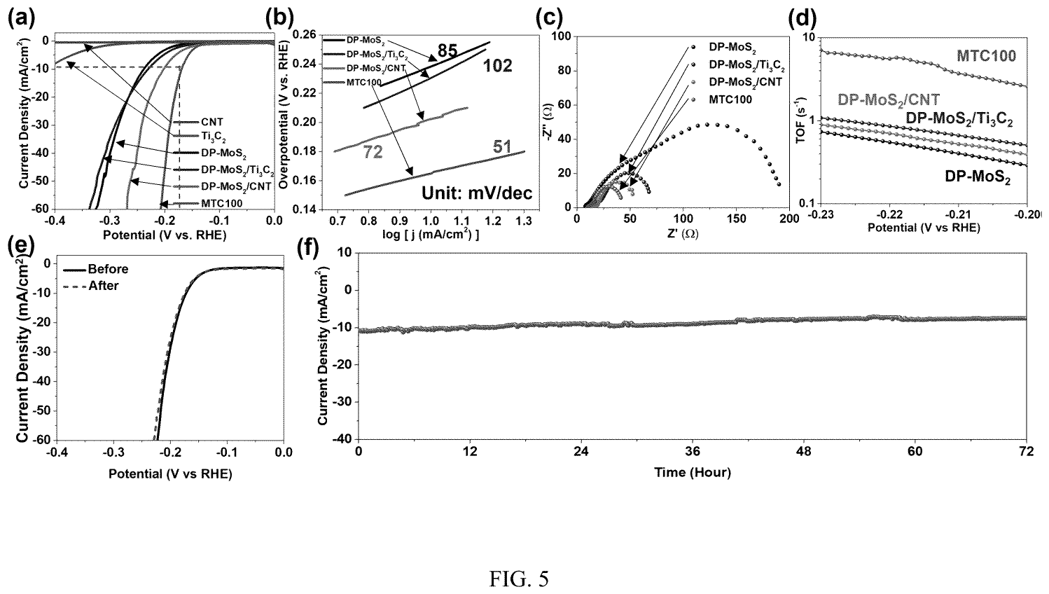

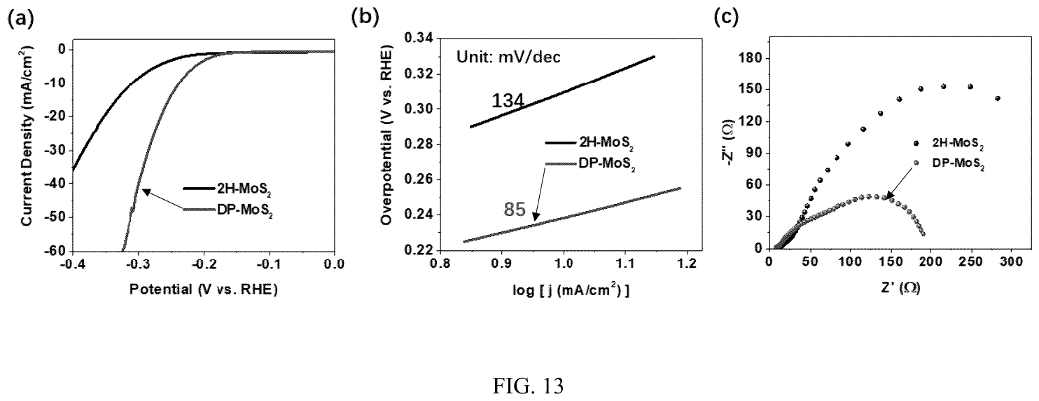

The electrochemical HER activity exploration of as-synthesized MoS₂-based electrocatalysts was conducted in 0.5 M H₂SO₄ using a standard three-electrode configuration with the built-in IR compensation function. FIGS. 5a and 5b display the LSV curves and corresponding Tafel plots of as-prepared samples. The pristine CNT and Ti₃C₂ MXene show nearly inert HER activity with a horizontal LSV curve pattern, indicating a limited HER activity of CNT and Ti₃C₂. The DP-MoS₂ exhibits a much lower overpotential of 238 mV at a current density of 10 mA/cm² (η10) and a low Tafel slope of 85 mV/dec due to the higher intrinsic catalytic capability of DP-MoS₂ compared to the aqueous-synthesized 2H—MoS₂ (FIGS. 13a and 13b). The enhanced HER performance can be ascribed to the significantly reduced charge transfer resistance (R_{ct}) associated with the high conductivity of the metallic 1T phase (FIG. 13c). In the case of binary composites, the DP-MoS₂/CNT enabled a better HER performance compared with DP-MoS₂/Ti₃C₂, evidenced by a lower overpotential and a smaller Tafel slope (202 mV, 72 mV/dec and 230 mV, 102 mV/dec for CNT and Ti₃C₂ composites, respectively), which can be attributed to the smaller R_{ct} of DP-MoS₂/CNT (see FIG. 5c) because of the higher conductivity of CNT with respect to Ti₃C₂ and the crosslink function of CNTs bridging different 2D MoS₂ islands (see FIG. 2e) for a universal conductive network formation. Among all the structures, MTC100 exhibits the lowest η10 of 169 mV and the smallest Tafel slope of 51 mV/dec, which can be associated with the smallest R_{ct}(see FIG. 5c) originated from the highest overall electrical conductivity via constructing a 1T-phase enriched MoS₂-based 1D/2D hybrid network. It is worth mentioning that the MTC100 shows excellent performance reproducibility. The overpotentials were found to be 169±5 mV for four different catalyst inks fabricated using the same batch of MTC100 sample that has been stored for around 1 year.

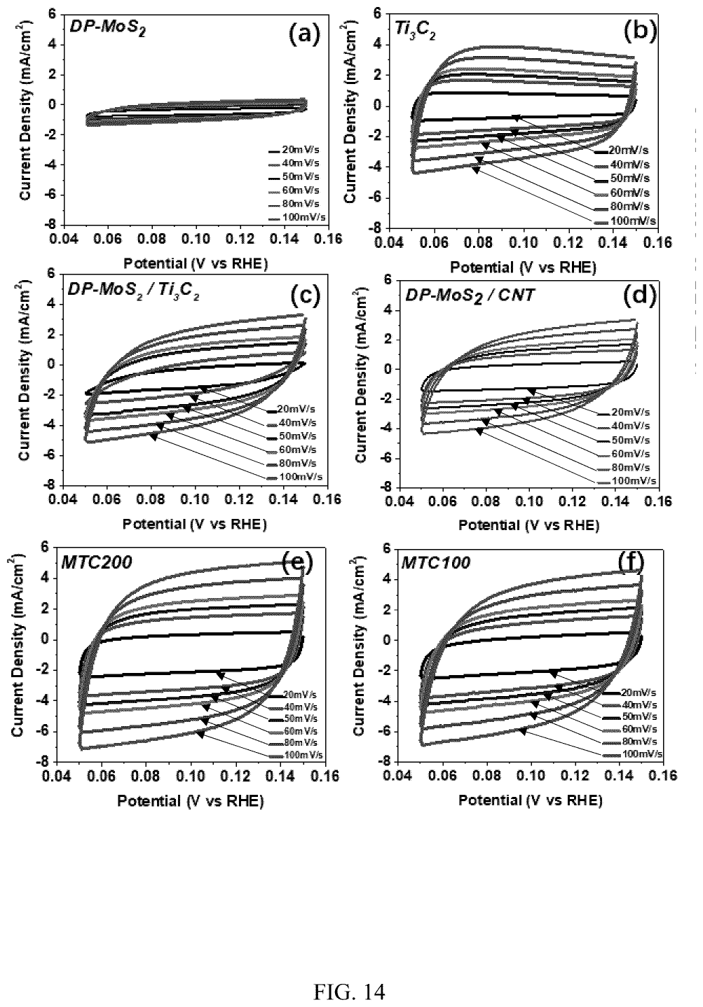

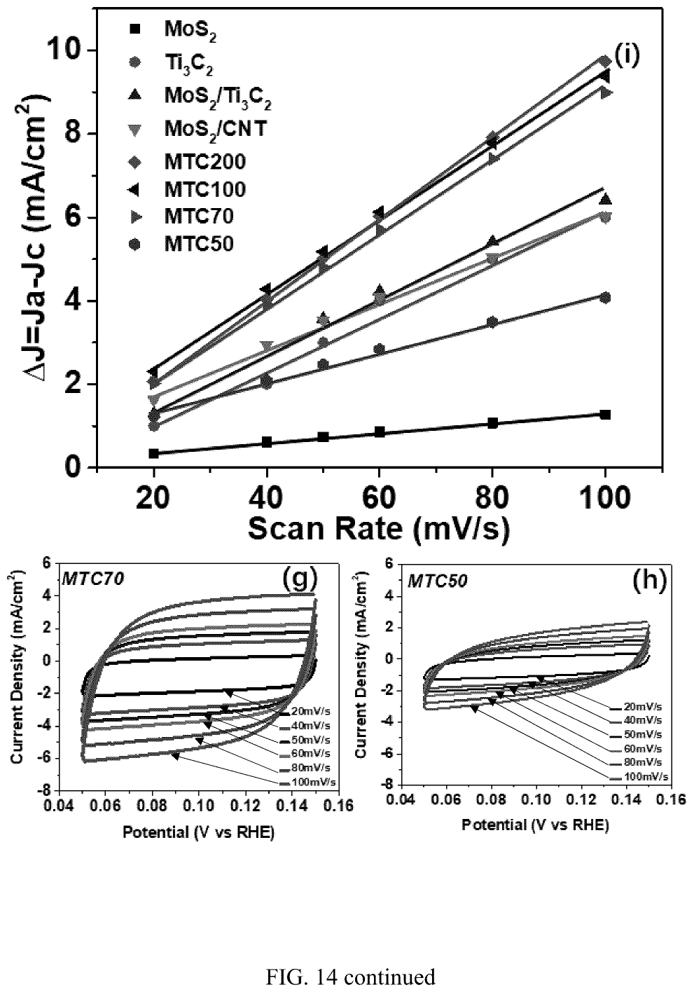

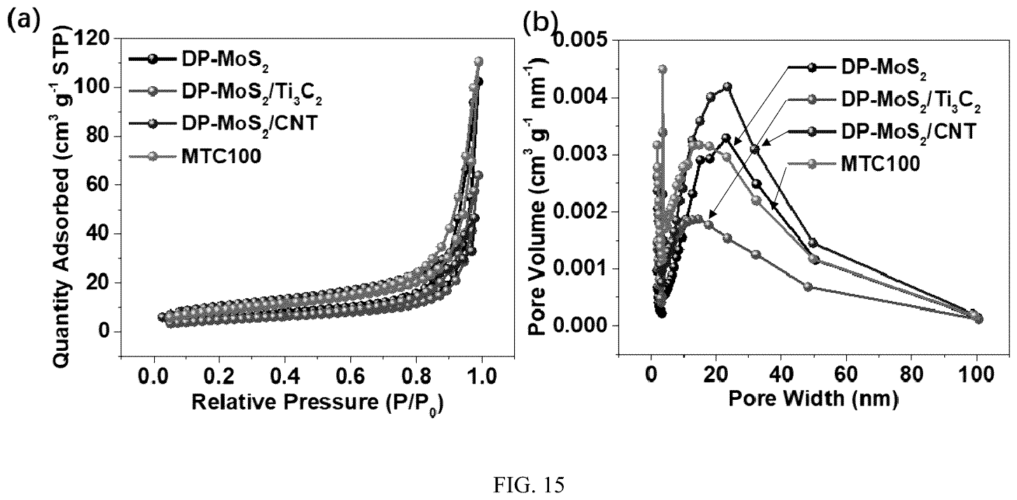

The CV was carried out to determine the double-layer capacitance (C_{dl}) and to calculate the electrochemical surface area (ECSA), as shown in FIG. 14. The measured C_{dl} for Ti₃C₂ MXene, DP-MoS₂, DP-MoS₂/Ti₃C₂, DP-MoS₂/CNT and MTC100 is 36, 6, 34, 27 and 44 mF/cm², and the corresponding ECSA are calculated to be 882, 144, 838, 676, and 1099 cm², respectively (see Table 1). The BET specific surface area was also tested by N₂ adsorption/desorption isotherm, as shown in FIG. 15a. The result shows that MTC100 contains the largest surface area of 32 m²/g, which is larger compared to the other binary composites (DP-MoS₂, DP-MoS₂/Ti₃C₂, and DP-MoS₂/CNT exhibit the BET area of 21, 18, and 28 m²/g, respectively). As can be seen in FIG. 15b, the pore size lies in the range of 10˜50 nm, suggesting a mesopore-enriched structure of the DP-MoS₂ hybrids. The enriched porosity feature can be attributed to the gas evolution during the solvothermal synthesis of the flower-shaped MoS₂-based hybrid structure and the integrated stacking nature of the 2D MoS₂/MXene layered hybrids. The turnover frequency (TOF) is another vital parameter to evaluate the activity of an HER electrocatalyst which characterizes the intrinsic activity of an electrocatalyst at a single active site. By combining the TOF with overpotential, it can provide a more comprehensive and in-depth view of the kinetics and a robust basis of catalytic benchmarking. The TOF values of the above-mentioned samples were calculated based on the CV measurement in a pH-neutral phosphate buffer solution and were plotted in FIG. 5d in the range of 0.2˜0.23 V. It is worth mentioning that the TOF of DP-MoS₂/CNT is lower than that of DP-MoS₂/Ti₃C₂ despite the smaller R_{ct} as shown in FIG. 5c, which is due to CNTs exhibit inherently low catalytic activity (see FIG. 5a) and limited contribution to the interlayer spacing expansion and surface area enlargement (see FIGS. 3a, 14, and 15). Among all the samples, DP-MTC100 exhibits a superior TOF corresponding to the observed higher catalytic activity compared to the other DP-MoS₂-based binary composites. The origin of the outstanding HER performance for the ternary composite lies in threefold: (i) the enlarged surface area due to the 2D/2D MoS₂/Ti₃C₂ integration and ion intercalation which promotes the contact between electrolyte and catalyst, leading to an increased hydrogen ion adsorption; (ii) the vertically grown MoS₂ flakes on the Ti₃C₂ template ensures the maximum exposure of MoS₂ edge planes which is beneficial to increase the total number of active sites; (iii) the synergistically enhanced conductivity due to the existence of 1T-phase enriched metallic MoS₂, the conductive backbone of Ti₃C₂ along with the crosslink function of CNTs, minimizing the charge transfer resistance at the electrode/electrolyte interface.

TABLE 1
The estimated C_{dl} and the corresponding
ECSA of different samples.

| Sample | C_{dl} (μF/cm²) | ECSA (cm²) |
|---|---|---|
| Ti₃C₂ | 36 | 882 |
| DP-MoS₂ | 6 | 144 |
| DP-MoS₂/Ti₃C₂ | 34 | 838 |
| DP-MoS₂/CNT | 27 | 676 |
| MTC200 | 48 | 1199 |
| MTC100 | 44 | 1099 |
| MTC70 | 43.5 | 1087 |
| MTC50 | 18 | 440 |

To investigate the cycling stability, the CV measurements between −0.2˜0.3 V were performed and the polarization curves before and after cycling are shown in FIG. 5e. A negligible shift of the polarization curve after 1000 CV cycles was observed, suggesting a long lifetime of DP-MTC100 in the acidic media. The superior ternary catalyst stability is benefited from the integration of MoS₂ with Ti₃C₂ which not only partially suppressed the Ti₃C₂ oxidation but also prevent the 2D layer restacking. In addition, it is known that the 1T phase MoS₂ is metastable and easily converted to the stable 2H phase, leading to the performance degradation of 1T metallic MoS₂-based devices. In this case, the NH₄ intercalation can serve as the electron donor to stabilize the 1T phase and therefore reduce the tendency of phase conversion. The ultralong time stability of DP-MTC100 is again confirmed by the time-dependent stability measurement as shown in FIG. 5f. The current density was measured at an overpotential of 169 mV and was stabilized at near 10 mA/cm² for 72 hours. The stability retention was extracted to be 95% at the 30 h and 77% at the 72 h, respectively. Nevertheless, activity loss can still be observed since the slow phase conversion of 1T to 2H and the mild oxidation of the structure still take place to a certain degree inevitably in a long run.

HER performance evaluation of MTC hybrids with different CNT ratios.

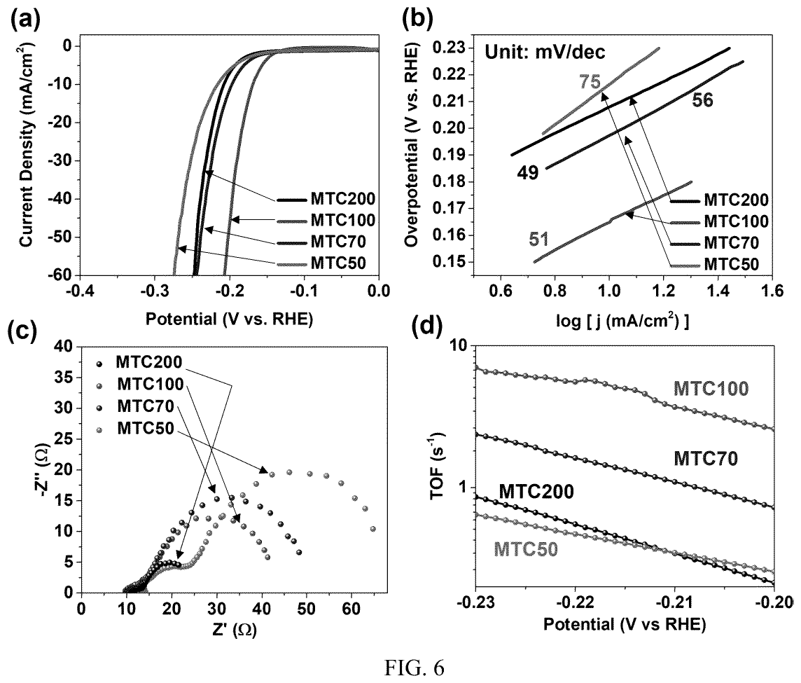

To optimize the HER activity, four different ternary DP-MTC samples were synthesized with different weights of CNTs (50, 70, 100, and 200 mg). As shown in FIG. 6, the MTC100 outperforms the other ternary hybrids, evidenced by the smallest overpotential (169 mV) and a small Tafel slope (51 mV/dec). It is noteworthy that MTC200 displays an even smaller Tafel slope (49 mV/dec) and the lowest R_{ct} value among the ternary composites (see FIGS. 6b and 6c), which can be ascribed to the higher ratio of CNTs that further enhanced the network conductivity and therefore charge transfer efficiency during the reaction. However, the TOF of MTC200 is one of the smallest among different CNT composites along with a large overpotential (216 mV), as shown in FIGS. 6a and 6d. It is well known that the number of active sites and the electrical conductivity are two vital factors for determining the HER activity of the electrocatalyst. In this case, the conductivity of the ternary composites improved significantly by adding more CNTs. However, the intrinsically low catalytic activity of CNT (see FIG. 5a) and its limited contribution to the surface area enlargement impacts the HER activity adversely. In addition, the relatively high CNT ratio will decrease the content of DP-MoS₂, leading to a decreased total number of active sites and therefore the catalytic activity correspondingly. Overall, the MTC100 provides a well-balanced relationship between the electrical conductivity and the number of active sites and therefore delivered the best catalytic performance for HER.

### Discussion

In summary, a ternary, dual-phase MoS₂/Ti₃C₂/CNT structure was successfully synthesized by a one-step solvothermal technique, and its HER activity was investigated. Such a ternary hybrid composite exhibited superior structure advantages compared to the other binary counterparts in terms of enlarged surface area, increased number of active sites, and a well-constructed 1D/2D hybrid conductive network. The 2D domains of metallic phase-enriched MoS₂ and the Ti₃C₂ conductive backbone were bridged by the 1D CNTs and therefore synergistically boosted the overall network conductivity. The composition-performance relationship interrogation revealed that the amount of CNTs in the composite is a determining factor for HER performance. The long-term catalytic stability was also achieved by the integration of MoS₂ with Ti₃C₂ in bisolvent media which effectively prevented the 2D layer restacking and partially suppressed the Ti₃C₂ oxidation. This work demonstrated an effective strategy for low-dimensional material structure-property engineering with the aim of optimizing the device performance and shedding light on the development of the next-generation PGM-free HER electrocatalysts.

### Methods

Materials. Anhydrous ethanol, lithium fluoride (LiF), hydrochloric acid (HCl), ammonium molybdate, thiourea and N, N-dimethylformamide (DMF) were purchased from Fisher Scientific, USA. Ti₃AlC₂ was purchased from Beijing Forsman Scientific Co. Ltd., China. Multiwalled carbon nanotubes (CNT) were purchased from XFNANO, China. All chemicals were used as received without any further purification.

Preparation of Ti₃C₂ MXene. The Ti₃C₂ was prepared by the in situ HF etching method. Specifically, 2 g LiF powder was slowly added into 40 ml HCl (9 M) solution and stirred for 30 minutes until the LiF was fully dissolved. 2 g Ti₃AlC₂ was slowly added into the LiF/HCl mixture which was placed in an ice bath subsequently. The solution was kept at 40° C. for 48 hours with continuous stirring. After the reaction, the black powder was collected by centrifugation and washed with DI water until the supernatant reached a pH value of 6. The powder was dried under vacuum at 60° C. for 12 hours.

Synthesis of the dual-phase MoS₂/Ti₃C₂/CNT (DP-MTC) ternary composite. 1 g of as-prepared Ti₃C₂ powder and 0.1 g CNT were added into 60 mL DI/DMF (volume ratio 1:1) bisolvent, followed by ultrasonication to form a homogenous suspension. 1.928 g ammonium molybdate and 3.645 g of thiourea were slowly added into the suspension and stirred until the precursors were well mixed. The suspension was then transferred into a 100 mL Teflon-lined autoclave and kept at 195° C. for 22 hours. After naturally cooling down to room temperature, the product was collected by centrifugation and washed with DI/ethanol, followed by vacuum drying at 60° C. for overnight. The as-prepared sample was denoted as DP-MTC100 where the number indicated the weight of CNT (100 mg). Different binary composites (MoS₂/Ti₃C₂, MoS₂/CNT) and MTC hybrid structures with different MXene to CNT ratios were also synthesized as control samples. To evaluate the influence of bisolvent impact in the synthesis, the MoS₂ powder and MoS₂/Ti₃C₂ composite (denoted as 2H—MoS₂ and 2H—MoS₂/Ti₃C₂, respectively) was also synthesized with the same precursor concentration in DI water as a reference sample.

Characterization. X-ray diffraction (XRD) was performed using a Rigaku Ultima IV with Cu Ka radiation (wavelength=1.541 nm). Raman spectra were collected using Renishaw InVia with an excitation laser wavelength of 514 nm. The morphologies of all products were investigated by field-emission scanning electron microscope (FE-SEM, Carl Zeiss AURIGA CrossBeam with Oxford energy dispersive x-ray spectra (EDS) system). The transmission electron microscopy (TEM) was conducted using the JEM ARM 200F system. X-ray photoelectron spectroscopy (XPS) was performed using a monochromatic Al Ka source (hv=1486.6 eV) (ESCALAB 250, Thermo Scientific). The Brunauer-Emmett-Teller (BET) measurements were conducted on a Micromeritics Tri-Star II system by nitrogen (N₂) adsorption-desorption isotherm at 77 K.

Electrochemical Measurements. The ink for the HER test was prepared by dissolving 10 mg of as-prepared powder in a mixture of 500 μL of ethanol, 500 μL of DI water, and 15 μL of Nafion D-521 solution. The electrochemical characterization was performed using CHI760E electrochemical workstation (CH Instrument) in a standard three-electrode system which consists of a silver/silver chloride (Ag/AgCl in 1M KCl), a platinum (Pt) wire, and an ink-coated glassy carbon rotating ring disc electrode as reference, counter and working electrodes, respectively. The loading amount of the sample is 0.285 mg/cm² and the samples were cycled 20 times before any data recording. Nitrogen gas saturated 0.5 M H₂SO₄ was employed as electrolyte. All the measured potentials were converted to the potential vs. E_{RHE} based on the equation: E_{RHE}=E_{Ag/AgCl}+0.059 pH+0.222. The linear sweep voltammetry (LSV) was carried out at a scan rate of 5 mV/s and the built-in IR compensation was executed prior to LSV tests. The electrochemical impedance spectroscopy (EIS, Biologic VMP3) was conducted from 0.1 Hz to 1 MHz with an amplitude of 5 mV at an overpotential of 250 mV vs. RHE. The electrochemical surface area was tested by cyclic voltammetry (CV) in the potential range of 0.05˜0.15 V vs. RHE with different scan rates (20, 40, 50, 60, 80, and 100 mV/s). The double-layer capacitance (C_{dl}) was assessed from the slope of the linear regression between the current density differences (ΔJ/2=(J_{anode}−J_{cathode})/2 at an overpotential of 0.1 V vs. RHE) versus the scan rates. The accessible surface area of as-synthesized samples could be approximated from the electrochemical active surface area (ECSA). The ECSA was determined by ECSA=C_{dl}/Cₛ, where Cₛ stands for the specific capacitance of standard electrode materials on a unit surface area. Here, based on the literature reported Cs values for carbon electrode materials, 0.04 mF/cm² was used for ECSA calculations. CV was performed between −0.3 V and 0.2 V vs. RHE to check the cycle stability.

### Example 2

This example provides a description of nanohybrid composites (e.g., binary nanohybrid composites) and methods of making same.

As an inexpensive and naturally abundant two-dimensional (2D) material, molybdenum disulfide (MoS₂) exhibits a high Li-ion storage capacity along with a low volume expansion upon lithiation, rendering it an alternative anode material for lithium-ion batteries (LIBs). However, the challenge of using MoS₂-based anodes is their intrinsically low electrical conductivity and unsatisfied cycle stability. To address the above issues, a wet chemical technique was used and MoS₂ with highly conductive titanium carbide (Ti₃C₂) MXene was integrated to form a 2D nanohybrid. The binary hybrids were then subjected to an n-butyllithium (n-BuLi) treatment to induce both MoS₂ deep phase transition and MXene surface functionality modulation simultaneously. A substantial increase of 1T-phase MoS₂ content and a clear suppression of —F containing functional groups in MXene were observed due to the prelithiation process enabled by the n-BuLi treatment. Such an approach not only increases the overall network conductivity but also improves Li-ion diffusion kinetics. As a result, the MoS₂/Ti₃C₂ composite with n-BuLi treatment delivered a high Li-ion storage capacity (540 mAh g⁻¹ at 100 mA g⁻¹), outstanding cycle stability (up to 300 cycles), and excellent rate capability. This work provides an effective strategy for the structure-property engineering of 2D materials and sheds light on the rational design of high-performance LIBs using 2D-based anode materials.

Herein is provided a design and experimental effort to trigger a deep phase transition of MoS₂ and engineer the surface functionality of MXene simultaneously. Dual-phase MoS₂ and Ti₃C₂ MXene hybrid obtained from the solvothermal method were used as starting materials and an n-butyllithium (n-BuLi) solution treatment was performed to prelithiate the nanocomposites. A substantial increase of 1T-phase content of MoS₂ from 50.3% to 75% and a clear suppression of —F containing functional groups in the MXene surface were observed due to the lithium-ion intercalation, leading to a clear improvement of the overall network conductivity and Li-ion diffusion kinetics. As a result, the n-BuLi treated MoS₂/Ti₃C₂ hybrid exhibits a reversible Li-ion storage capacity of−540 mAh g⁻¹ for 300 cycles at 100 mA g⁻¹ with a clearly improved rate capability compared with the pristine nanohybrid.

### Methods

Materials. Anhydrous ethanol, lithium fluoride (LiF), hydrochloric acid (HCl), ammonium molybdate, thiourea and N, N-dimethylformamide (DMF), n-Butyllithium (n-BuLi) in Hexane solution, Hexane and N-Methyl-2-pyrrolidone (NMP) were purchased from Fisher Scientific, USA. Ti₃AlC₂ was purchased from Beijing Forsman Scientific Co. Ltd., China. Super P and Polyvinylidene fluoride (PVDF) were purchased from AOT Electronics Technology Co., LTD, China. All chemicals were used as received without any further purification.

Preparation of Ti₃C₂ MXene. The Ti₃C₂ was prepared by the in situ HF etching method. Specifically, 2 g LiF powder was slowly added into 40 ml HCl (9 M) solution and stirred for 30 minutes until the LiF was fully dissolved. 2 g Ti₃AlC₂ was slowly added into the LiF/HCl mixture which was placed in an ice bath subsequently. The solution was kept at 40° C. for 48 hours with continuous stirring. After the reaction, the black powder was collected by centrifugation and washed with DI water until the supernatant reached a pH value larger than 6. The powder was dried under vacuum at 60° C. for 12 hours.

Synthesis of the dual-phase MoS₂/Ti₃C₂ composite. 1 g of as-prepared Ti₃C₂ powder was added into 60 mL DI water/DMF bisolvent, followed by ultrasonication to form a homogenous suspension. 1.928 g ammonium molybdate and 3.645 g of thiourea were slowly added into the suspension and stirred until the precursors were well mixed. The suspension was then transferred into a 100 mL Teflon-lined autoclave and kept at 195° C. for 22 hours. After naturally cooling down to room temperature, the product was collected by centrifugation and washed with DI water and ethanol for at least 5 times, followed by vacuum drying at 60° C. for overnight. The as-prepared composite is denoted as p-MT.

Preparation of n-BuLi treated MoS₂/Ti₃C₂. 0.5 g of p-MT was dried in a vacuum oven at 100° C. for overnight in order to remove the moisture in the powder. The dried powder was then transferred into Ar filled glovebox (02<0.01 ppm, H₂O<0.01 ppm). 10 ml n-BuLi/Hexane solution was slowly added into the powder in order to avoid the vigorous reaction and the sample was kept in the glovebox for 15 days to allow the thorough reaction to occur. The n-BuLi treated sample is denoted as n-MT. After the reaction, the n-MT was firstly washed with Hexane for 5 times inside the glovebox to remove the excessive n-BuLi, then the product was extracted from the glovebox and washed with DI water by vacuum filtration to wash out the Hexane residual. In the end, the sample was dried in a vacuum oven overnight.

Characterization. X-ray diffraction (XRD) was performed using a Rigaku Ultima IV with Cu Ka radiation (wavelength=0.154 nm). Raman spectra were collected using Renishaw InVia with an excitation laser wavelength of 514 nm. The morphologies of all products were investigated by field-emission scanning electron microscope (FE-SEM, Carl Zeiss AURIGA CrossBeam with Oxford energy dispersive x-ray spectra (EDS) system). X-ray photoelectron spectroscopy (XPS) was performed using a monochromatic Al Ka source (hv=1486.6 eV) (ESCALAB 250, Thermo Scientific).

Electrochemical Measurements. The Li-ion battery electrode performance was evaluated in a half-cell configuration in a type CR2032 coin cell. The coin cell was fabricated in Ar filled glovebox (02<0.01 ppm, H2O<0.01 ppm) with n-MT or p-MT as working electrodes, LiPF₆ in EC/DMC as the electrolyte, and Li foil as counter/reference electrode, respectively. The working electrode was prepared by mixing the nanocomposite, Super P, and PVDF in the weight of 8:1:1 in NMP, and then doctor-bladed on the Cu current collector followed by drying in a vacuum oven. Galvanostatic charge-discharge and Cyclic Voltammetry (CV) were tested in the potential range of 0˜3V vs. Li/Li⁺ with current density and scan rate of 0.1 A/g and 0.05 mV/s, respectively. The electrochemical impedance spectrum (EIS) was tested at open circuit potential with the frequency range of 10 mHz to 100 kHz with the amplitude of 5 mV. All the electrochemical tests were performed on Biologic VMP3 Potentialstat at room temperature.

### Results and Discussion

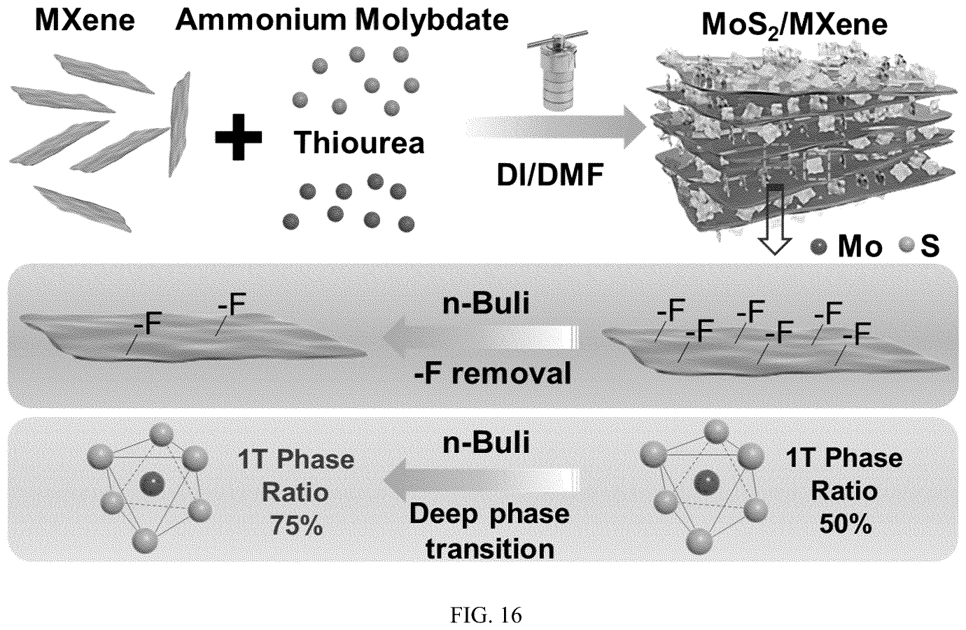

As shown in FIG. 16, the p-MT composite was synthesized using a bisolvent solvothermal method reported previously. Briefly, accordion-like Ti₃C₂ MXene flakes were produced by the in-situ HF etching method. To be more specific, the reaction between HCl and LiF will in situ produce HF which can effectively etch off the Al layer from Ti₃AlC₂ precursor by breaking the relatively weak Ti—Al bond compared to Ti—C bond. The obtained Ti₃C₂ flakes were then added into DI water/DMF bisolvent together with ammonium molybdate and thiourea powders which served as Mo and S sources, respectively. The use of bisolvent not only induces the phase transition of MoS₂ from semiconducting 2H to metallic 1T phase by NH₄⁺ ion intercalation but also prevents the undesired oxidation of MXene, leading to the improvement of conductivity and stability of the hybrid structure simultaneously. The as-prepared p-MT sample was then soaked into n-BuLi/Hexane solution for 15 days in the glovebox to obtain the n-MT sample. As an organolithium reagent, n-BuLi has been widely used as an intercalating agent for 2D materials exfoliation. It is considered that the n-BuLi treatment can further improve the composite electrochemical performance in the following aspects (see the bottom panels in FIG. 16): (i) increase the conductivity of MoS₂ by Li-ion interaction to trigger deep phase transition of MoS₂; (ii) reduce the content of F-containing functional groups which are known for adversely affecting the battery performance.

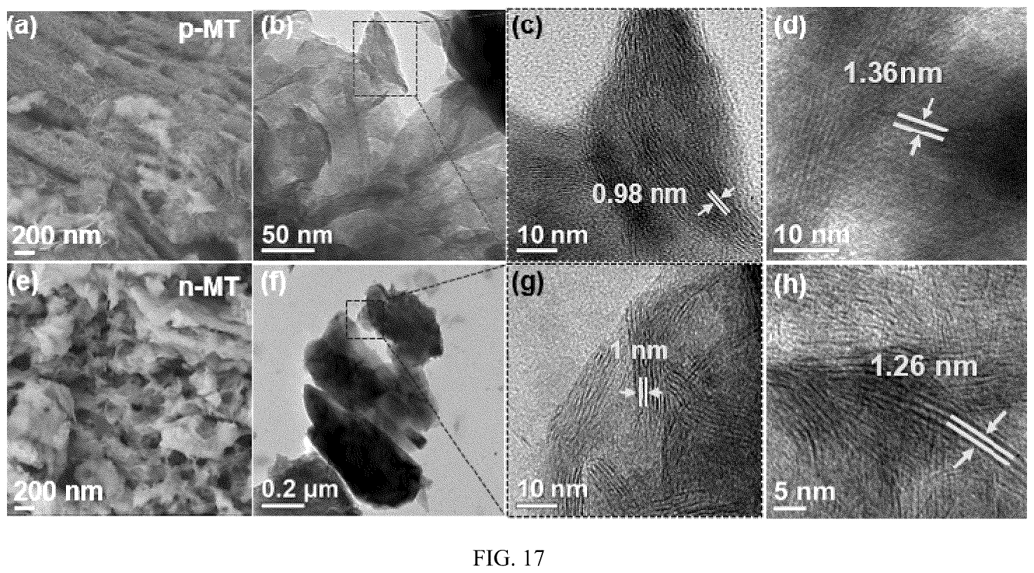

To investigate the structure and composition of the products, a series of characterizations were conducted. The SEM and TEM images of p-MT are shown in FIGS. 17a and 17b where MoS₂ flakes were found uniformly wrapped around the Ti₃C₂layers. The interlayer distance of MoS₂ and Ti₃C₂ in p-MT was extracted from HRTEM images (FIGS. 17c and 17d), and the values are 0.98 nm and 1.36 nm, respectively. These values are found to be larger than the reported values for pure 2H phase MoS₂ (0.64 nm) obtained from in situ sulfurization method and Ti₃C₂ flakes (1 nm) from typical HF technique. The increased interlayer space can be ascribed to the NH₄ ion intercalation during the solvothermal synthesis process and the integrated stacking nature of the 2D layers which will be beneficial for facile ion transport during battery operation.

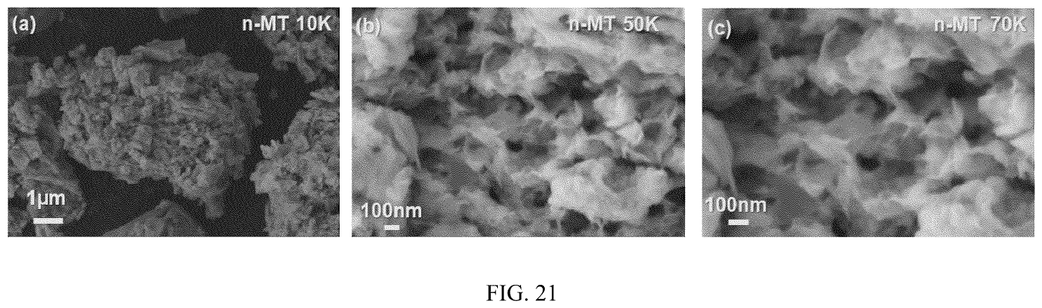

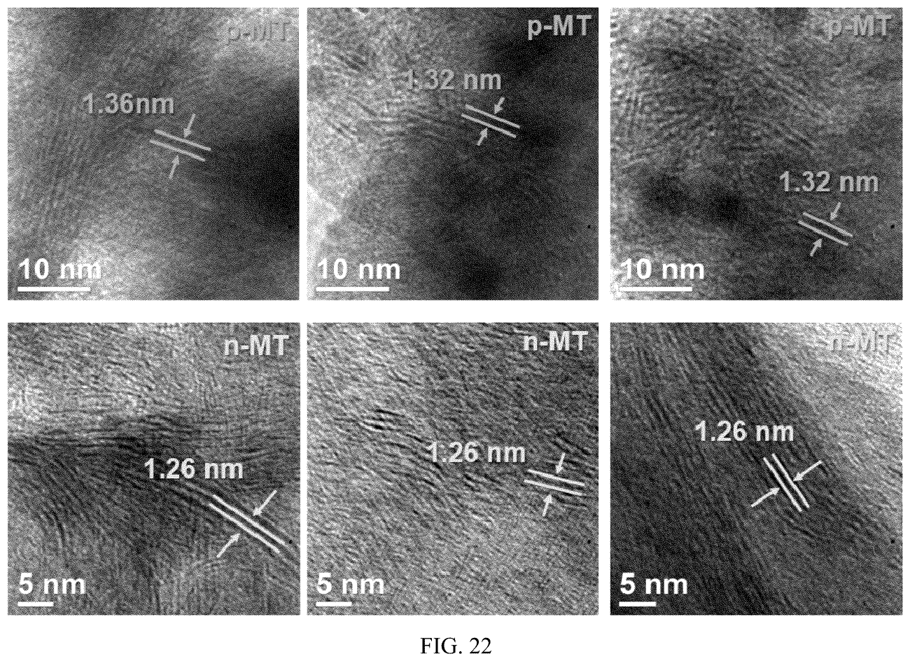

The SEM and TEM images of n-MT are shown in FIGS. 17e and 17f where distinct, largely expanded features were observed. It is considered that the severe structure evolution after n-BuLi treatment is related to the H₂ gas generation along with heat production originating from the vigorous reaction between n-BuLi and the small amount of water residual trapped within the 2D composite. Additional SEM images of n-MT can be found in FIG. 21. The HRTEM images of n-MT are shown in FIGS. 17g and 17h and the interlayer distance of MoS₂ and Ti₃C₂ MXene was extracted to be 1 nm and 1.26 nm, respectively. The interlayer distance of MoS₂ is almost unchanged compared to the one in p-MT but decreased in the case of Ti₃C₂ MXene after n-BuLi treatment (see more HRTEM images in FIG. 22 and a detailed discussion can be found in the following section). The EDS mappings can be found in FIG. 23 with uniformly distributed MoS₂ and MXene related elements suggesting the existence of MoS₂ and Ti₃C₂ MXene components in the composite before and after n-BuLi treatment. The presence of oxygen species can be attributed to the presence of oxygen functional groups in MXene along with the unavoidable sample oxidation. A low —F content was detected in both p-MT and n-MT. However, the atomic ratio of the —F content was clearly reduced in n-MT (0.3%) compared to that of p-MT (11.1%) after the n-BuLi treatment, which is expected to reduce the diffusion barrier of Li ions and therefore improve the rate performance of battery anode.

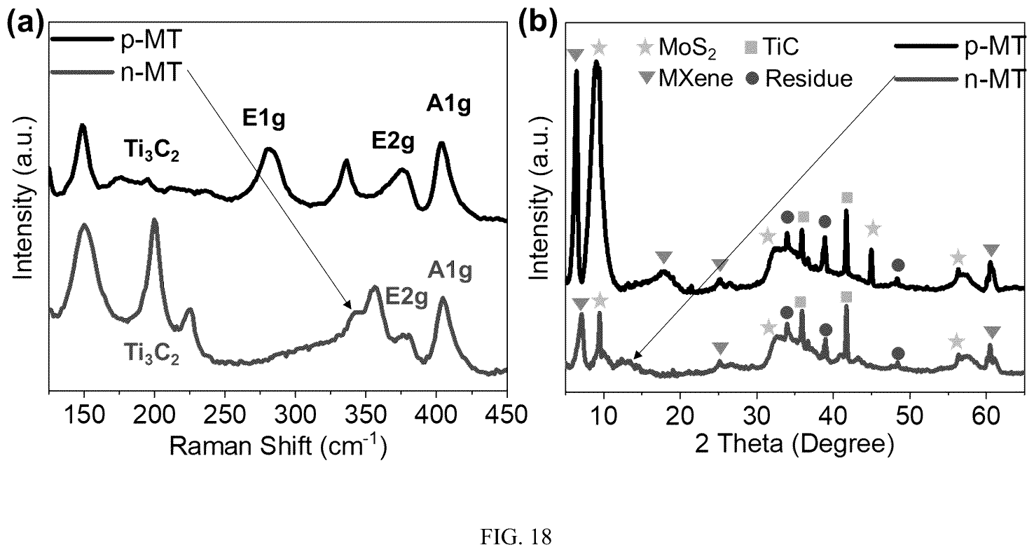

FIG. 18a shows the Raman spectra of p-MT and n-MT. Clear E_{1g} (280 cm⁻¹), E_{2g} (377 cm⁻¹), and A_{1g} (404 cm⁻¹) peaks corresponding to the vibration of atoms along in-plane (E_{1g}, E_{2g}) and out-of-plane (A_{1g}) directions have been detected in p-MT and are in good agreement with the previous reported 2H-phase MoS₂. In addition, the observation of the vibration peaks at 151 cm⁻¹ and 336 cm⁻¹ suggests a clear 1T phase in p-MT. The formation of the 1T phase is triggered by the NH₄⁺ ion intercalation introduced during the bisolvent synthesis process where both ammonium molybdate and DMF act as the abundant source of NH₄⁺ ion. Specifically, the intercalated NH₄⁺ can stimulate the charge imbalance between Mo³⁺ and Mo⁴⁺ and cause the S plane sliding and therefore the MoS₂ crystal structure distortion, resulting in the phase transformation from 2H to 1T eventually.

In the case of n-MT, four 1T phase-related peaks located at 150, 225.6, 340 and 356 cm⁻¹ corresponding to the previously reported Li intercalated MoS₂ are well observed. It is worth mentioning that the intensities of both A_{1g} and E_{2g} peaks are reduced in n-MT compared with p-MT, indicating a less content of the 2H phase in n-MT. Furthermore, the E1g mode was not detectable in n-MT which can be ascribed to the swollen and enlarged MoS₂ features after Li intercalation inducing a relatively less amount of edge plane exposure under the laser spot. In addition, it can be seen that a peak at 225.6 cm⁻¹ emerged in n-MT due to the structure distortion along with potential defect generation after n-BuLi treatment. The enhanced peak at 200 cm⁻¹ can be attributed to the increased exposure of Ti₃C₂ MXene layers resulting from the microstructure evolution of MoS₂ after n-BuLi treatment where sparser MoS₂ layers were observed.

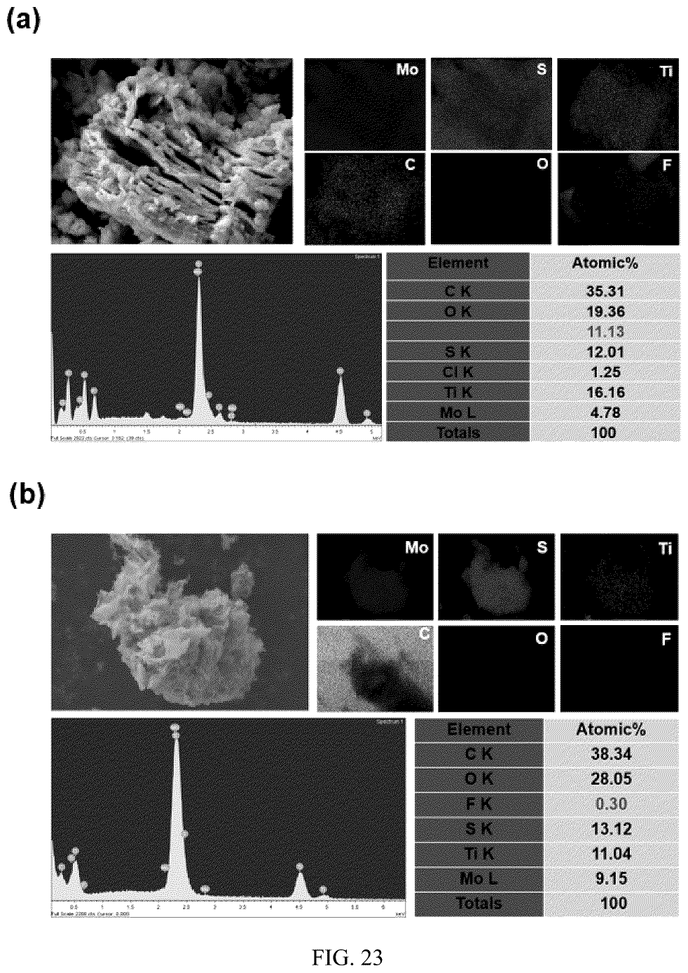

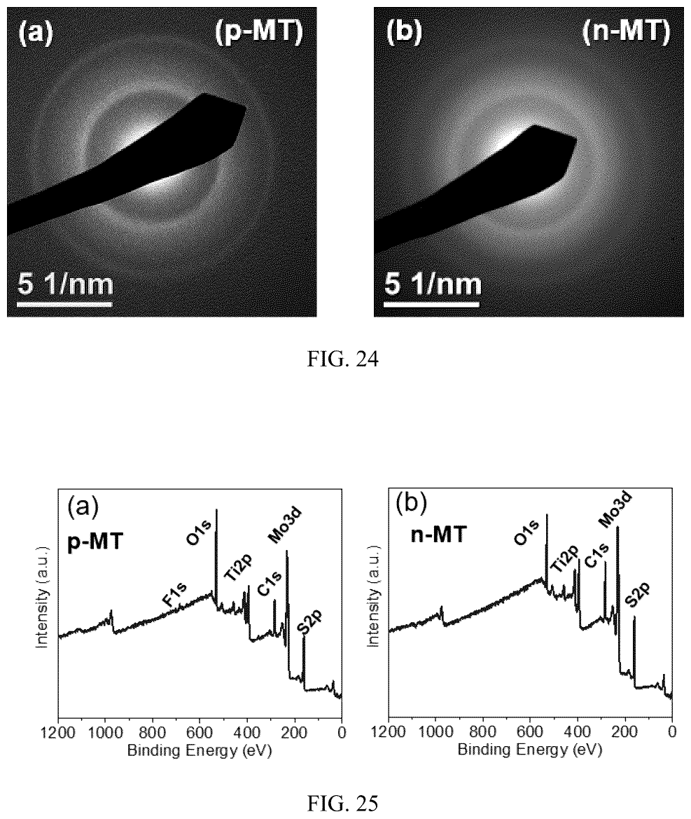

The XRD pattern of both samples can be found in FIG. 18b. The diffraction pattern of p-MT shows obvious diffraction peaks at 6.47, 17.8, 25.27, and 60.47 degrees, which can be correlated to the Ti₃C₂ MXene (002), (006), (008), and (110) planes, respectively. The MoS₂-related diffraction peaks at 9.2, 32.3, 44.6, and 56.9 degrees were clearly observed, corresponding to the (002), (100), (006), and (110) planes, respectively. Two peaks located at 35.9 and 41.7 degrees are attributed to the TiC, which is originally from the Ti₃AlC₂ precursor. Additional weak peaks (marked with purple dots) were also observed from both samples which can be ascribed to the Al-related residue from the wet chemical etching process. The interlayer spacing of Ti₃C₂ and MoS₂ was calculated via Bragg's diffraction equation and the values are 1.36 nm and 0.96 nm, respectively, which is in line with the HRTEM results shown in FIGS. 18c and 18d. In the case of n-MT, clear peak intensity reduction and the disappearance of (006) plane-related peaks in both MXene and MoS₂ can be observed, indicating a decreased structural crystallinity after n-BuLi treatment. This result is also in agreement with the 225.6 cm¹ Raman peak emergence in n-MT (FIG. 18a) which was attributed to the higher defect density in MoS₂ after lithiation. The amorphous ring features shown in the SAED pattern (see FIG. 24) also suggest a poor crystallinity resulting from the intercalation of NH₄⁺ and/or Li⁺ ions. The amorphous nature of the binary composites is beneficial for the MoS₂-based anode performance due to the increased ion intercalation sites and reduced ion diffusion resistance.

It is worth mentioning that although the MoS₂ (002) peak does not show a clear change in n-MT, the Ti₃C₂ (002) peak upshifts to 7.12 degrees corresponding to a reduced interlayer spacing of 1.26 nm compared with the p-MT, which echoes well with the TEM result shown in FIGS. 17 and 22. In the case of MoS₂, the interlayer distance remained similar after n-BuLi treatment can be understood since sufficient interlayer expansion has been achieved via NH₄⁺ ion intercalation during the bisolvent synthesis process. In the case of MXene, the reduction of interlayer distance upon lithiation can be ascribed to the moisture loss and electrostatic interactions between the inserted Li ions and the inherently negatively charged MXene layers. In addition, the de-functionalization of the F-containing group in the MXene layers could also contribute to the interlayer space reduction (see discussion in the session below).

The XPS was performed to provide further insight into the chemical constitution and phase information. The complete survey of p-MT and n-MT is shown in FIGS. 25a and 25b, respectively. A small peak located at ˜685 eV corresponding to the F is signal was detected in p-MT, whereas there was no obvious peak emerged in the range of 600˜800 eV for n-MT. The deconvoluted F is spectrums for both samples are shown in FIGS. 24a and 24d. The peak in p-MT is clear and can be deconvoluted into Ti—F and Al—F related bonds, originating from the incomplete etching of the Al layer in the Ti₃AlC₂ phase using LiF. However, only a tiny Ti—F bond-related signal was observed in n-MT, suggesting the effective removal of F-containing functional groups from the Ti₃C₂ MXene after n-BuLi treatment which corresponds well to the observation in FIG. 23. The reduction of F-containing functional groups can be attributed to the Ti—F bond weakening and cleavage upon Li⁺ ion intercalation during the n-BuLi treatment.

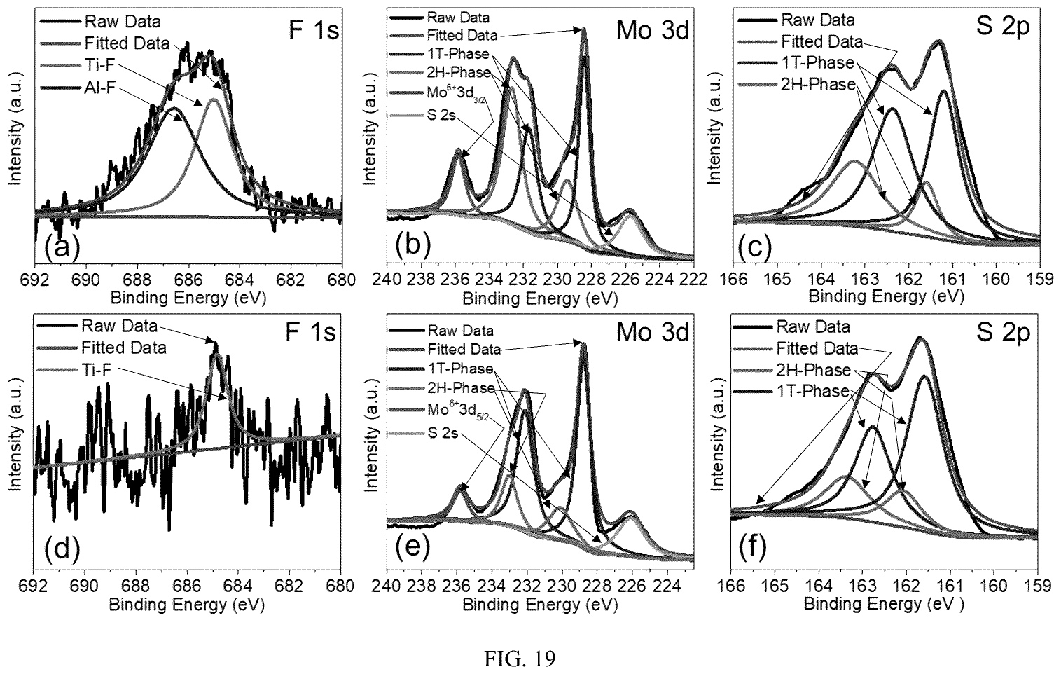

To investigate the MoS₂ phase transition in these two samples, the Mo 3d spectrums were deconvoluted and the related results are shown in FIGS. 19b and 19e. In p-MT (see FIG. 19b), two sets of peak doublets located at 229.5/232.7 eV and 228.5/231.7 eV were observed which can be assigned to the 2H (pink line) and 1T phases (blue line) of MoS₂, respectively. A similar analysis was done for the n-MT sample and the 1T phase ratio was calculated according to the area of the peaks. The result shows that the n-MT exhibits a higher 1T phase ratio (75%) compared to that of p-MT (50%). FIGS. 19c and 19f exhibit the deconvoluted S 2p spectrums of the two samples where two sets of peak doublets at 162.1/163.4 eV and 161.6/162.75 eV were observed, corresponding to the 2H (pink line) and 1T phases (blue line), respectively, and a higher 1T phase ratio of 74% was also detected in n-MT. The above results demonstrate that a deeper phase transition of MoS₂ and surface functionality modulation of MXene has been successfully achieved by the n-BuLi treatment which is expected to improve the anode performance in terms of stability and rate capability because of the improved conductivity and facile Li⁺ diffusion in the hybrid associated with the increased amount of 1T metallic MoS₂ phase along with a higher population of defective sites and the reduced amount of F-containing functional groups which has a higher Li⁺ diffusion barrier in MXene.

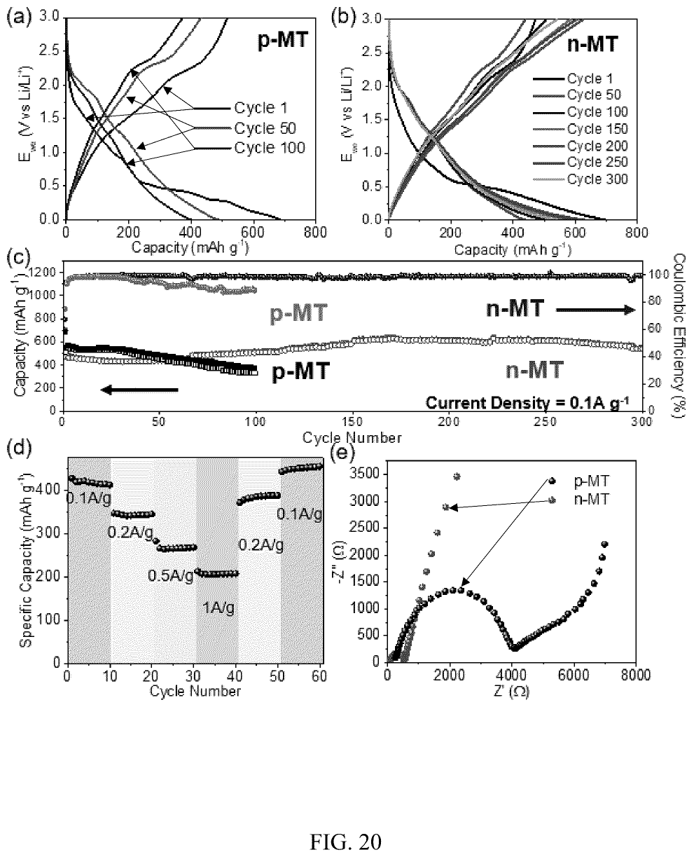

The electrochemical battery performance for both samples was evaluated by galvanostatic charge/discharge (GCD) at a current density of 0.1 A g¹ in the potential window of 0.01˜3 V (versus Li/Li⁺) FIG. 20a displays the GCD curves of p-MT. In the first lithiation process, the plateaus observed at ˜1 V and 0.5 V are associated with the Li-ion intercalation into MoS₂ forming the LiₓMoS₂ (see equation 1) with the phase transformation from 2H to 1T and its further lithiation to form Mo nanoparticles embedded in Li₂S matrix (see equation 2). In the first delithiation process, two plateaus at 1.5 V and 2.2 V are correlated to the oxidation of Mo to MoS₂ (equation 3) and the transformation of Li₂S into S (equation 4), respectively. In the following charge/discharge cycles, two sets of plateaus can be identified. The plateaus at 1.86 V (discharge)/2.25 V (charge) and 1.3 V (discharge)/1.6 V (charge) can be assigned to the redox couples of S/Li₂S and MoS₂/Mo (equations 3 and 4), respectively. The p-MT nanocomposite delivers a high initial lithiation capacity of 687 mAh g⁻¹ followed by a delithiation capacity of 516 mAh g⁻¹ in the first cycle. The large irreversible capacity can be attributed to solid-electrolyte interface (SEI) formation which could originate from electrolyte decomposition. At the 100^{th} charge/discharge cycle, a delithiation capacity of 330 mAh g⁻¹ is observed.

$$\begin{matrix}{MoS}_{2} + {xLi}^{+} + {xe}^{-} \to {Li}_{x} {MoS}_{2} & ( 1 ) \\ {Li}_{x} {MoS}_{2} + 4 ( 1 - x ) {Li}^{+} + ( 4 - x ) {e}^{-} \to Mo + 2 {Li}_{2} S & ( 2 ) \\ Mo + 2 {Li}_{2} S ⇆ {MoS}_{2} + {Li}_{x} {MoS}_{2} + 4 {Li}^{+} + 4 {e}^{-} & ( 3 ) \\ 2 {Li}_{2} S ⇆ 2 S + 4 {Li}^{+} + 4 {e}^{-} & ( 4 )\end{matrix}$$

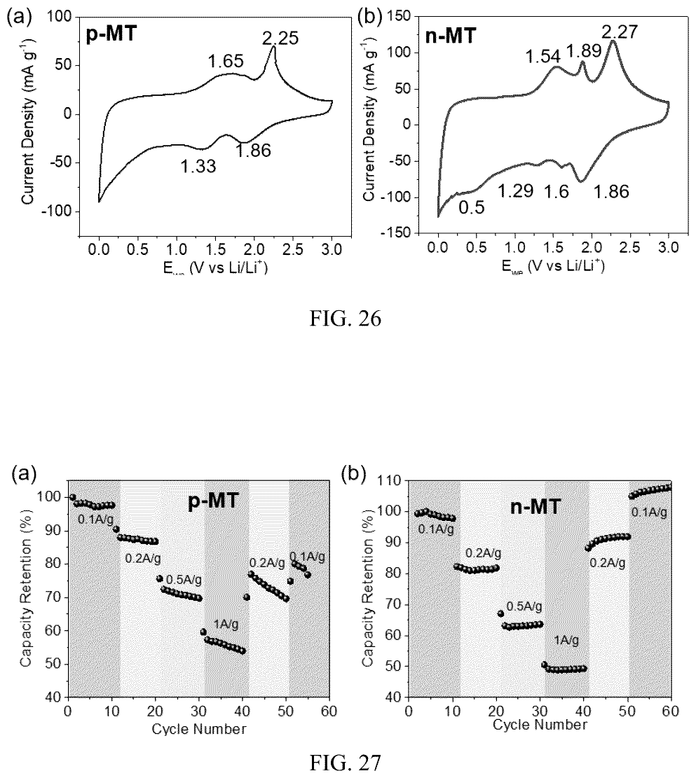

In the case of n-MT (FIG. 20b), two distinct features in charge/discharge profiles can be observed in contrast to p-MT. First, the absence of the plateau at ˜1 V can be explained as the pre-existence of LiₓMoS₂ in n-MT induced by the n-BuLi treatment. This observation also suggests a high 1T phase content in n-MT which is in line with observations in FIG. 19. Second, despite general plateau formations associated with LiₓMoS₂ decomposition and reversible reactions between S/Li₂S and MoS₂/Mo can be identified (equations 2-4), the plateaus are not as obvious as the p-MT due to the severe layered structure deformation after the n-BuLi treatment (see FIG. 17e). The CV curves of the hybrid 2D composites can be found in supporting FIG. 26 which correspond well with the charge/discharge profile. The n-MT nanohybrids delivered a similar initial lithiation capacity to that of p-MT (˜701 mAh g⁻¹) but showed a minor decrease up to the 50^{th} cycle and then increased to a higher capacity in the following cycles. For instance, the delithiation capacities at the 100^{th} and 200^{th} cycles were found to be ˜508 and 610 mAh g⁻¹, respectively. The slow increase of the capacity can be attributed to the activation process of the electrode material upon cycling which gradually generates micro-channels for electrolyte ion transport, and therefore effectively enhance the Li ion intercalation/extract efficiency. Eventually, the n-MT composite maintained a delithiation capacity of 540 mAh g⁻¹ at the 300^{th} cycle, demonstrating superior Li-ion storage capacity compared to the p-MT and pure MoS₂ or Ti₃C₂ MXene samples (see Table 2).

FIG. 20c shows the comparison of the cycling stability of p-MT and n-MT composites at a constant current density of 100 mA g⁻¹. The Coulombic efficiency (CE) of p-MT and n-MT at the beginning of the cycling is 75% and 67%, respectively. In the following cycles, the CE of the p-MT anode decreases to 88% at the 100^{th} cycle along with severe capacity fading. In sharp contrast, the n-MT nanocomposite shows a much more stable cycling performance with a stable Coulombic efficiency of 99.6% up to the 300^{th} cycle. The superior cycling performance of the n-MT hybrid electrode is closely related to its better electrical conductivity arising from a higher 1T phase MoS₂ content and the reduction of the F-content in the nanohybrids benefiting from the n-BuLi treatment. In addition, the prelithiation process of n-MT nanohybrid could compensate for the active lithium losses in the subsequential cycles which is also beneficial for the anode stability. FIG. 20d shows the rate capability of the n-MT composites. The hybrid electrode presents an excellent rate capability with the reversible capacities of 430, 350, 268, and 214 mAh g⁻¹ at different current densities of 0.1, 0.2, 0.5, and 1A g⁻¹, respectively, which is obviously more stable than p-MT (see FIG. 27). When the current density returns to 0.1 A g⁻¹, the specific capacity recovers to a high-capacity value of 454 mAh g⁻¹.

To further study the electrochemical reaction kinetics of the samples, the electrochemical impendence spectra (EIS) tests were performed, and the results are shown in FIG. 20e. The resulting Nyquist plots consist of a depressed semicircle in the high-frequency range and a tail in the low-frequency range. In general, the series resistance (Rₛ) and the charge transfer resistance (R_{ct}) can be extracted from the first point where Z″=0 and the diameter of the semicircle, respectively. The slope of the straight line is aligned with the Warburg impendence (Z_{w}), which is associated with the diffusion of the lithium ions in the electrode materials. Compared to the p-MT sample (Rₛ=90Ω), a smaller value of Rₛ (20Ω) is observed in the nanohybrids after n-BuLi treatment, suggesting an improved electrical conductivity of the electrode associated with the higher 1T phase content, which is corresponding to the analysis in FIGS. 18 and 19. The smaller R_{ct} value and a steeper slope of the straight line in n-MT demonstrate a facile charge transfer process at the electrode/electrolyte interface and a fast ion diffusion process, respectively, which can be attributed to the more dispersed 2D layers and a lower —F containing functional groups after the n-BuLi treatment.

TABLE 2
The LIB anode performance comparison.

| | | Capacity | |
|---|---|---|---|
| Material | Cycles | (mAh/g) | Reference |
| MoS₂ | 100 | 256 | ACS Nano 2011, 5, 6, 4720-4728. |
| MoS₂ | 70 | 163 | Nanoscale 2012, 4, 95-98. |
| MoS₂ | 200 | ~300 | Angew. Chem. Int. Ed. 2015, 54, 7395-7398. |
| Ti₃C₂Tₓ | 50 | ~160 | Nano Energy 2017, 34, 249-256. |
| Ti₃C₂Tₓ | 100 | ~30 | Nano Energy 2016, 30, 603-613. |
| Ti₃C₂Tₓ | 1000 | ~60 | ACS Appl. Mater. Interfaces 2018, 10, 3634-3643. |
| MoS₂/Mo₂TiC₂Tₓ | 100 | 509 | Angew. Chem, Int. Ed. 2018, 57, 1846. |
| MoS₂/Ti₃C₂Tₓ | 70 | 331 | Inorg. Chem. Front. 2019, 6, 117-125. |
| MoS₂@Ti₃C₂ | 200 | 131.6 | J. Electrochem. Soc. 2017, 164, A2654. |
| n-MT | 330 | 450 | This Work |

In summary, a 2D MoS₂/Ti₃C₂ composite composed of 1T phase enriched MoS₂ flakes and functional group regulated Ti₃C₂ MXene sheets was successfully prepared using a bisolvent synthesis method followed by an n-BuLi enabled prelithiation process. Compared with the materials without such treatment, the prelithiated nanohybrids exhibit a distinct surface morphology with higher 1T metallic phase MoS₂ and lower content of F-based functional groups which are beneficial for the battery anode performance due to the enhanced electrical conductivity and reduced Li diffusion barrier. As a result, a clearly improved Li-ion storage capacity along with excellent cycle stability is achieved. This work demonstrates an effective strategy for low-dimensional material structure-property engineering to optimize the battery anode performance. The heterostructures with high Li-ion storage capacity demonstrated in this study also shed light on the development of other 2D hybrid-based energy storage and conversion systems.

Although the present disclosure has been described with respect to one or more particular embodiments and/or examples, it will be understood that other embodiments and/or examples of the present disclosure may be made without departing from the scope of the present disclosure.

1. A nanohybrid composite comprising dual-phase MoS₂ and a plurality of MXene layers, wherein about 30 to about 90% of the MoS₂ is 1T phase.

2. The nanohybrid composite of claim 1, further comprising a plurality carbon nanotubes.

3. The nanohybrid composite of claim 1, wherein the nanohybrid composite comprises about 50 to about 90 wt % dual phase MoS₂.

4. The nanohybrid composite of claim 1, wherein the nanohybrid composite comprises about 10 to about 50 wt % MXene.

5. The nanohybrid composite of claim 1, wherein the nanohybrid composite comprises about 0 to about 20 wt % carbon nanotubes.

6. The nanohybrid composite of claim 1, wherein each layer of the plurality of MXene layers independently comprises Ti₃C₂, Ti₂C, Mo₂C, Nb₂C, Nb₄C₃, V₂C, V₄C₃, Ta₄C₃, Hf₃C₂, Ti₂N, W₂N, V₂N, Mo₂TiC₂, Mo₂Ti₂C₃, or any combination thereof.

7. The nanohybrid composite of claim 1, the nanohybrid composite further comprising a plurality of ammonium ions.

8. The nanohybrid composite of claim 1, wherein the nanohybrid composite comprises a double-layer capacitance of greater than or equal to about 40 mF/cm².

9. The nanohybrid composite of claim 1, wherein the nanohybrid composite comprises an electrochemical surface area of greater than or equal to about 1000 cm².

10. The nanohybrid composite of claim 1, wherein the nanohybrid composite comprises an overpotential less than or equal to about 180 mV.

11. The nanohybrid composite of claim 1, wherein the nanohybrid composite comprises a charge transfer resistance of less than about 10 ohm.

12. The nanohybrid composite of claim 2, wherein the nanohybrid composite comprises a charge transfer resistance of less than about 20 ohm.

13. The nanohybrid composite of claim 1, wherein at least a portion or all of the plurality of MXene layers are stacked, and the dual-phase MoS₂ is disposed between adjacent MXene layers.

14. The nanohybrid composite of claim 2, wherein at least a portion or all of the plurality of MXene layers are stacked and the dual-phase MoS₂ is disposed between adjacent MXene layers, and each carbon nanotube contacts one or more of the MXene layers and/or dual-phase MoS₂.

15. The nanohybrid composite of claim 1, wherein the nanohybrid composite comprises about 10% or less fluorine and/or fluoride.

16. A method of making a nanohybrid composite, comprising:
contacting one or more liquid(s), a MXene, a sulfur precursor, a molybdenum precursor, optionally, an ammonium precursor, and, optionally, carbon nanotubes to form a reaction mixture;
heating the reaction mixture;
isolating a reaction product from the reaction mixture; and
optionally, contacting the reaction product with a lithiated base,
wherein the reaction product is the nanohybrid composite.

17. The method of claim 16, further comprising, prior to the contacting, etching a MXene precursor chosen from Ti₃AlC₂, Mo₂Ga₂C, Nb₂AlC, Nb₄AlC₃, V₂AlC, V₄AlC₃, Ta₄AlC₃, Mo₂TiAlC₂, Mo₂Ti₂AlC₃, Hf₃[Al(Si)]₄C₆, Ti₂AlN, and any combination thereof, with one or more etching method(s) chosen from acidic aqueous solvent etching, alkali aqueous solvent etching, non-aqueous solvent etching, electrochemical etching, halogen etching, molten salt etching, and any combination thereof, wherein the MXene is formed.

18. The method of claim 16, wherein the MXene is chosen from Ti₃C₂, Ti₂C, Mo₂C, Nb₂C, Nb₄C₃, V₂C, V₄C₃, Ta₄C₃, Hf₃C₂, Ti₂N, W₂N, V₂N, Mo₂TiC₂, Mo₂Ti₂C₃, and any combination thereof;
wherein the molybdenum precursor is ammonium molybdate, molybdenum oxide, sodium molybdate, and any combination thereof,
wherein the ammonium precursor is ammonium molybdate, ammonium heptamolybdate (NH₄Mo₇O₂₄), ammonium molybdate tetrahydrate ((NH₄)₆Mo₇O₂₄·4H₂O), ammonium tetrathiomolybdate ((NH₄)₂MoS₄), ammonium thiomolybdate ((NH₄)₂Mo₃S₁₃), and any combination thereof, and
wherein the sulfur precursor is chosen from thiourea, sulfur powder, sodium thiocyanate, sodium sulfide, L-cystine, ammonium polysulfide ((NH₄)₂Sₓ), ammonium tetrathiomolybdate ((NH₄)₂MoS₄), ammonium thiomolybdate ((NH₄)₂Mo₃S₁₃), and any combination thereof.

19. The method of claim 16, wherein the liquid(s) comprise deionized water and one or more organic solvent(s).

20. A method according to claim 19, wherein the liquid(s) comprise about 20 to about 50% deionized water, based on a total volume of the liquid(s) and the remaining percent by volume of the liquid(s) comprises the organic solvent.

21. An anode comprising one or more nanohybrid composite(s) of claim 1.

22. The anode of claim 21, wherein the anode is a hydrogen evolution reaction (HER) anode.

23. A device comprising one or more anode(s) of claim 21.

24. The device of claim 23, wherein the device is a battery, supercapacitor, fuel cell, electrolyzer, or electrolytic cell.
